(19) United States
(12) Patent Application Publication
(10) Pub. No.: US 2023/0205800 A1
(43) Pub. Date: Jun. 29, 2023

(54) SYSTEM AND METHOD FOR DETECTION AND AUTO-VALIDATION OF KEY DATA IN ANY NON-HANDWRITTEN DOCUMENT

(71) Applicant: Eliahu Kadoori AVIVI, Alfey Menashe (IL)

(72) Inventor: Eliahu Kadoori AVIVI, Alfey Menashe (IL)

(21) Appl. No.: 17/927,883

(22) PCT Filed: Jun. 21, 2021
(86) PCT No.: PCT/IL2021/050749

§ 371 Date: Nov. 27, 2022

Related U.S. Application Data
(60) Provisional application No. 63/041,946, filed on Jun. 21, 2020.

(51) Int. Cl. G06F 16/383; G06F 16/35; G06V 30/40

(52) U.S. Cl. CPC G06F 16/383; G06F 16/35; G06V 30/40

(57) ABSTRACT

A computerized-method for classifying a document and detecting and validating key data within the document is provided herein. The computerized-method includes (i) receiving a stream of uniform format documents, for each document in the stream of uniform format documents, operating a textographic analysis module to: (a) determine a category, an author and recipient of each document and (b) detect one or more key data, based on the determined category to ascribe each detected key data to corresponding one or more data fields within the document; (ii) operating a textographic-learning module on the received stream of uniform format; (iii) validating each determined key data in each document; and (iv) displaying via a display unit, the category, author, recipient and the validated key data of each document in the stream of uniform format documents.

### TECHNICAL FIELD

The present disclosure relates to the field of data analysis and more specifically to processing and extracting and validating relevant data from documents and automatically correcting Optical Character Recognition (OCR) errors.

### BACKGROUND

An Optical Character Recognition (OCR) process of a document is a tool which is used to recognize text in any document, while converting it into a computer file. The recognized printed text by an OCR software, may include errors or unrecognized words and numbers. Even when the accuracy level of the OCR process, is as high as 99%, it means that, on average, one error is expected out of every hundred words. This problem of having, on average, at least one error out of hundred words, is currently forcing intensive manual intervention to detect and correct such errors.

Nowadays, organizations are receiving a high volume of documents which they are often required to classify by content and to extract key data therefrom. The fact that some of these documents may include text, which may be only partly recognized after an OCR process, may prevent them from having a full automation of processing a high volume of documents, thus the costs of human labor may not be reduced.

For example, a full automation of processing a high volume of scanned or photographed commercial and financial documents such as, invoice, bill of lading, purchase order, receipt and alike may be impossible, and instead—organizations are expending costly human efforts to detect and correct intolerable OCR errors in pricing, quantities, description of relevant supplied items or services, etc.

Even when the documents include no OCR errors at all, an automatic understanding of the contents of any document and accurately extracting relevant key data from the document, may be a complicated task by itself. Therefore, the fact that any OCR processed document, may include erroneous data, which should be also automatically detected and corrected without human intervention or verification, is even more challenging.

Accordingly, there is a need for a technical solution that will fully automate accurate extraction of key data in big data documents, if any, to enable automatic document classification and processing and avoid any need of human intelligence intervention for validation or correction of the documents.

### SUMMARY

There is thus provided, in accordance with some embodiments of the present disclosure, a computerized-method for classifying a document and detecting and validating key data within the document.

Furthermore, in accordance with some embodiments of the present disclosure, the computerized method may include receiving a stream of uniform format documents, for each document in the stream of uniform format documents, operating a textographic analysis module to: (a) determine a category, an author and recipient of each document by: (i) extracting features of the document and features of one or more data field within it; and (ii) comparing the extracted features to prestored characteristics of one or more categories of documents in the data storage; (b) detect one or more key data, based on the determined category to ascribe each detected key data to corresponding one or more data fields within the document.

Furthermore, in accordance with some embodiments of the present disclosure, the computerized method may further include operating a textographic-learning module on the received stream of uniform format documents to: (a) sort documents in stream of uniform format documents into groups of look-alike documents; (b) store in a data storage the extracted features of the one or more data fields for the ascribed key data, for each group of look-alike documents; and (c) assign each document in the stream of uniform format documents to a group of look-alike documents and store the assignment of each document in the data storage.

Furthermore, in accordance with some embodiments of the present disclosure, the computerized method may further include validating each determined key data in each document, in the stream of uniform format documents, by matching features of each data field ascribed to the one or more key data to corresponding recognized features of one or more data fields which are ascribed to same key data in the assigned group of look-alike documents.

Furthermore, in accordance with some embodiments of the present disclosure, the computerized method may further include displaying via a display unit, the category, author, recipient and the validated key data of each document in the stream of uniform format documents.

Furthermore, in accordance with some embodiments of the present disclosure, the sort of the documents in stream of uniform format documents into groups of look-alike documents may be operated by detecting common features of documents having the same category, author and recipient.

Furthermore, in accordance with some embodiments of the present disclosure, the extracting features of the document and of each data field within the document may include: (a) determining a graphical structure; (b) detecting page header and footer to validate an author; (c) detecting and validating a recipient; (d) detecting one or more strings to derive category of document; (e) detecting: (i) a subject of the document; (ii) a reference number; (iii) dates; (iv) creation date and time; (v) key data; (f) converting numeric data to a predetermined format; (g) detecting one or more tabular structures to validate data within each column in the detected one or more tabular structures; and (h) detecting one or more strings which imply chapters and paragraphs.

Furthermore, in accordance with some embodiments of the present disclosure, each document in the received stream of uniform format documents may be in any language and each document may have been received in a digital uniform format or may have been converted to a digital file by operating a scanning software on a paper-document.

Furthermore, in accordance with some embodiments of the present disclosure, when the received document is a paper-document that has been converted to a digital file, the computerized-method is further comprising: applying an image enhancement operation to yield an enhanced image by eliminating noise and other distortions, and then resizing an enhanced image of each page of the received document into a preconfigured size with uniform margins.

Furthermore, in accordance with some embodiments of the present disclosure, the computerized-method may further include applying an Optical Character Recognition (OCR) process to the enhanced image to detect text within the image and to yield a uniform format document.

Furthermore, in accordance with some embodiments of the present disclosure, the detected text within the image includes one or more OCR errors which are erroneous recognition of the text within the image and the detecting and validating key data in the document may be further operating an OCR-error correction model according to the validation of key data.

Furthermore, in accordance with some embodiments of the present disclosure, the predetermined format may be a standard format that is used in the United States of America.

Furthermore, in accordance with some embodiments of the present disclosure, the validating data within each column in the detected one or more tabular structures may further include determining a pattern of the data. The pattern of the data may be selected from at least one of: (i) an alphanumeric string; (ii) a numeric string.

Furthermore, in accordance with some embodiments of the present disclosure, the numeric string may be followed by a measurement unit or the measurement unit may be specified within a header of the column in which the numeric string is located.

Furthermore, in accordance with some embodiments of the present disclosure, the validating data within each column in the detected one or more tabular structures may further include verifying that each numeric data field in a column has the same format and the same font.

Furthermore, in accordance with some embodiments of the present disclosure, a validating data of each numeric data field within each column in the detected one or more tabular structures comprising identifying a subtotal in a column of numeric data fields.

Furthermore, in accordance with some embodiments of the present disclosure, the identifying of subtotal may further include checking: (i) a subtotal equals a summation of one or more preceding numeric data in same column; (ii) a print of the numeric data field as bolder or larger font than the other numeric data fields in the same column (iii) a vertical gap between the identified subtotal and a preceding numeric data field in the same column exceeds the average vertical gap between the rest of the preceding numeric data fields in the same column; (iv) a horizontal line exists between the identified subtotal and a preceding number in the same column; (v) a horizontal line between other preceding numeric fields which is in a different length; and (vi) a total number of words in a line is lower than a total number of words in former lines.

Furthermore, in accordance with some embodiments of the present disclosure, the stream of uniform format documents may include documents in Portable Document Format (PDF).

Furthermore, in accordance with some embodiments of the present disclosure, the graphical structure may be determined based on: (i) a location and length of each vertical line in every page of the document; (ii) a location and length of each horizontal line in every page of the document; (iii) coordinates of left edge and right edge of a printed area in the document, text-line height, vertical gap between top of the text-line and bottom of the preceding text-line; (iv) detection of column structures, separated by vertical lines or by “white vertical gaps”; (v) coordinates of left edge and right edge of each string within the document, string height, font size, font type, bold or italic features of each string, proportional or monospaced font, combination type of characters of each string.

Furthermore, in accordance with some embodiments of the present disclosure, a vertical line may be a sequence of pixels, which are positioned in a horizontal coordinate, that at least a preconfigured percentage of them are of same color, and a total sequence height that exceeds twice the maximal character height within a page in the document.

Furthermore, in accordance with some embodiments of the present disclosure, a horizontal line may be a sequence of pixels, which are positioned in a vertical coordinate, that at least a preconfigured percentage of them are of same color, and a total sequence width that exceeds twice the maximal character width within a page in the document.

Furthermore, in accordance with some embodiments of the present disclosure, the preconfigured percentage is 95%.

Furthermore, in accordance with some embodiments of the present disclosure, each category and author and recipient may include one or more groups of look-alike documents.

Furthermore, in accordance with some embodiments of the present disclosure, uploading each document to related one or more applications in a computerized system of an organization based on the determined category of each document.

There is thus further provided herein a computerized-system for classifying a document. The computerized-system may include: a processor; a data storage; a memory to store the data storage; and a display unit.

Furthermore, in accordance with some embodiments of the present disclosure, the processor may be configured to: (i) receive a stream of uniform format documents, for each document in the stream of uniform format documents, operating a textographic analysis module to: (a) determine a category, an author and recipient of each document by: (i) extracting features of the document and features of one or more data field within it; and (ii) comparing the extracted features to prestored characteristics of one or more categories of documents in the data storage; (b) detect one or more key data, based on the determined category to ascribe each detected key data to corresponding one or more data fields within the document; (ii) operate a textographic-learning module on the received stream of uniform format documents to: (a) sort documents in stream of uniform format documents into groups of look-alike documents; (b) store in a data storage the extracted features of the one or more data fields for the ascribed key data, for each group of look-alike documents; and (c) assign each document in the stream of uniform format documents to a group of look-alike documents and store the assignment of each document in the data storage; (iii) validate each determined key data in each document, in the stream of uniform format documents, by matching features of each data field ascribed to the one or more key data to corresponding recognized features of one or more data fields which are ascribed to same key data in the assigned group of look-alike documents; and (iv) display via a display unit, the category, author, recipient and the validated key data of each document in the stream of uniform format documents.

### BRIEF DESCRIPTION OF THE DRAWINGS

FIG. 1 schematically illustrates a high-level diagram of a computerized-system for classifying documents and detecting and validating key data within the document, in accordance with some embodiments of the present disclosure;

FIGS. 2A-2B are a high-level workflow of a computerized-method for classifying a document and detecting and validating key data within the document, in accordance with some embodiments of the present disclosure;

FIGS. 3A-3B are a high-level workflow of extracting features of the document and of each data field within the document, in accordance with some embodiments of the present disclosure;

FIGS. 4A-4D shows examples of scanned paper-documents, in accordance with some embodiments of the present disclosure.

FIG. 5 shows an example which includes an invoice in Hebrew with two tabular structures in accordance with some embodiments of the present disclosure;

FIG. 6 shows an example of an invoice having low quality image and noise within it, and item prices that the OCR software did not recognize, in accordance with some embodiments of the present disclosure; and

FIG. 7 is an example of a visual structure and layout of the table to determine a location of “border line” between different items within a table, regardless of the document language.

### DETAILED DESCRIPTION

In the following detailed description, numerous specific details are set forth, in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

The term “word” as used herein refers to any string of alpha-numeric characters, including numbers, delimited by a space or another punctuation.

The term “string” as used herein refers to any data field in a document.

The term “addressee” and the term “recipient” are interchangeable.

The term “word” and the term “data field” are interchangeable.

The terms “document type”, “classification” and “category” are interchangeable and refer to a document which is received by a receiver from a transmitter, e.g., author such as, invoice, vehicle insurance policy, pricelist, lawsuit, insurance policy, purchase order etc.

The term “document” relates to any non-handwritten electronic document in a Portable Document Format (PDF).

A high volume of documents may be received in many organizations from suppliers, job candidates, and other sources. Part of these documents are received as paper-documents, which should be scanned and interpreted by an Optical Character Recognition (OCR) software, to be later on uploaded to a related application in the computerized system of the organization. For uploading a document to related one or more applications in the computerized system of the organization, the document should be classified into a relevant category of documents such as, invoice, pricelist, insurance policy, etc., so it can be processed accordingly.

Also, every OCR error should be corrected in the received document. The processes of correcting OCR errors and of sorting received documents into relevant categories, are currently performed manually and are time consuming, which requires costly human resources.

Accordingly, there is a need for a system and method for full automation of document contents processing, including automatic detection of scanned and photographed documents, so that any OCR error within such documents will be corrected. The automatic processing of any electronic document includes automatic classification of each document into the relevant category and extraction of all relevant key data. Thus, enabling uninterrupted automatic processing and avoiding human intelligence intervention for validating or correcting any data which should be processed.

Furthermore, the needed system and method should enable uploading each document to related one or more applications in a computerized system of an organization based on a determined category of each document.

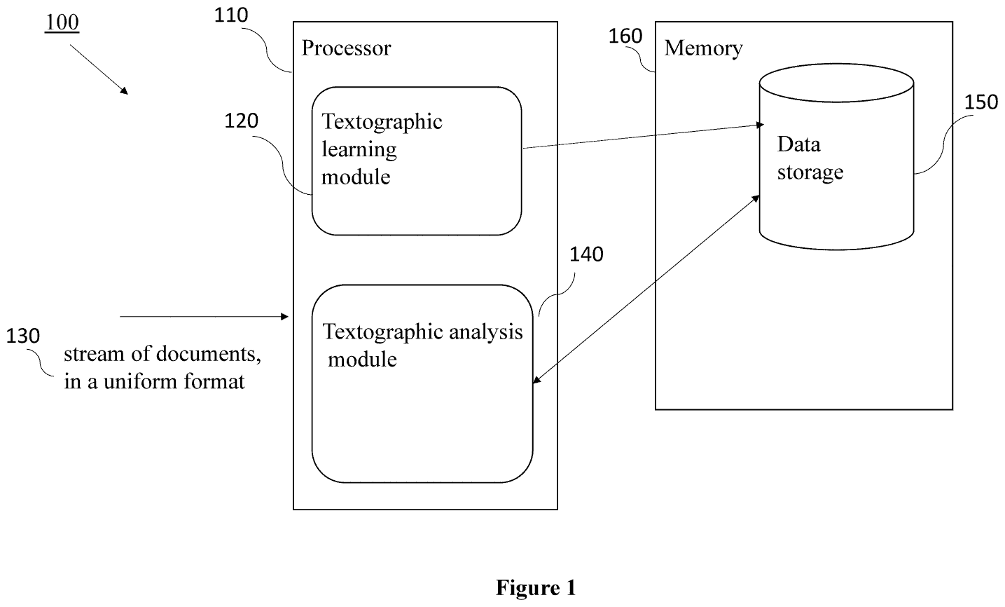

FIG. 1 schematically illustrates a high-level diagram of a computerized-system 100 for classifying documents and detecting and validating key data within the document, in accordance with some embodiments of the present disclosure.

According to some embodiments of the present disclosure, a “textographic analysis” may be a detailed analysis, which is combining the visual layout of each page, e.g., logo and headers, footers, chapter and paragraph structures, vertical and horizontal line locations, column structures, etc., as well as its language and the location, contents, data type and graphical characteristics of each word within the document. A word may be any combination of alphanumeric characters with any other one or more symbols.

According to some embodiments of the present disclosure, a processor, such as processor 110 may be configured to operate a textographic analysis module, such as textographic analysis module 140. The textographic analysis may result with a file, detailing the layout of the relevant document, as described below, such a layout is expected to be similar to the layout of other documents of the same type and from the same author, as well as the details of every word within the document.

According to some embodiments of the present disclosure, the language of each document may be determined by relevant statistics on the type of characters and words within the document, or by using relevant freeware, which determines the language, like TESSERACT OCR freeware, sponsored by Google, which may also determine the document language.

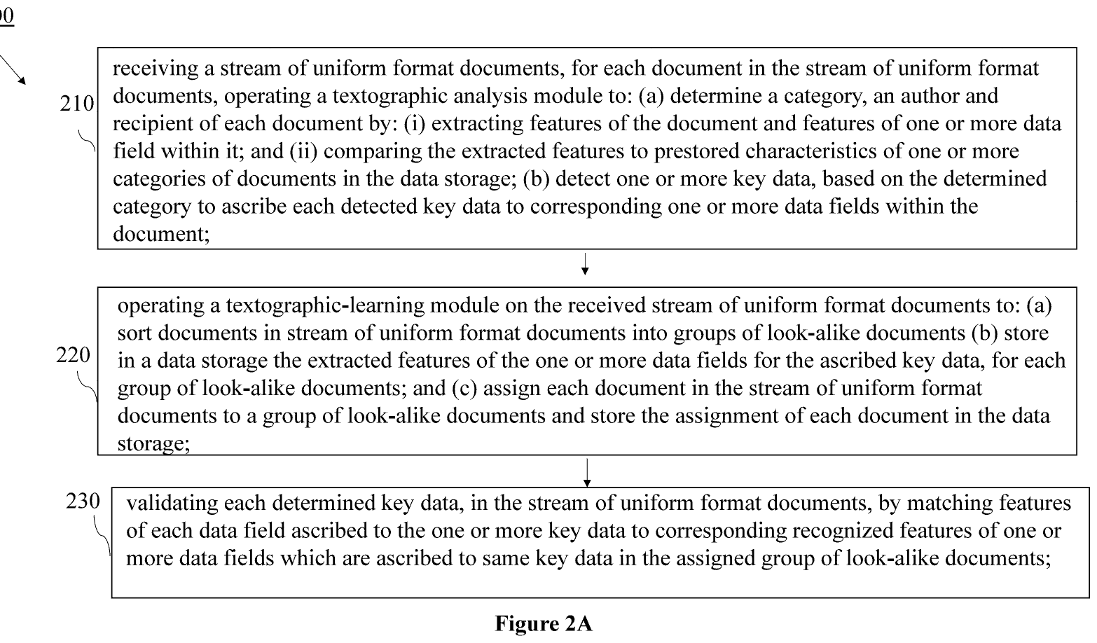

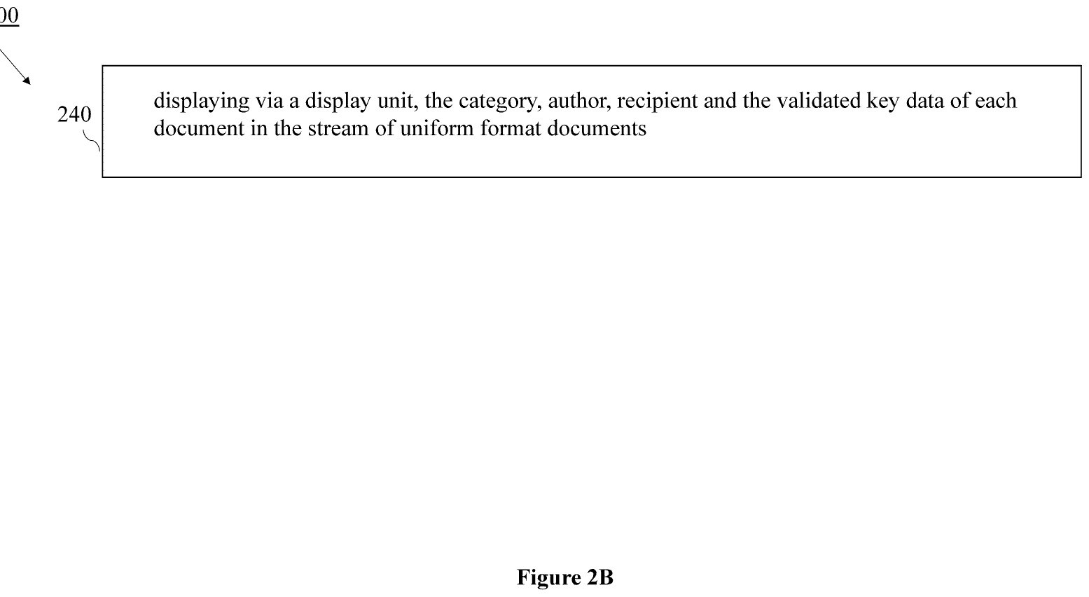

According to some embodiments of the present disclosure, a detailed textographic analysis of each word, e.g., data field, may be performed as in the following example. In this example the analyzed word is “215.71”—and a result of a detailed textographic analysis might be:
(1) Word location within the document: (a) Page number: 2. (b) Line number: 14. (c) word number within the relevant line: 3. (d) Distance from the left edge of the page to the left side of the word: 90 mm. (e) Distance from the top of the page to the top of the word: 190 mm.
(2) Graphical characteristics: (a) Font type: Times New Roman bold. (b) Font Size: 14. (c) Width of the “virtual rectangle” which bounds the word: 20 mm. (d) Height of the “virtual rectangle” which bounds the word: 4 mm. (e) Number of characters: 6. (f) Average character width: 2 mm. (g) Space between word and next word in the same line: 6 mm.
(3) Word is part of a fluent text line or within a table structure: (a) table. A table structure may be determined by detecting large gaps or significantly unequal spaces between words in the relevant line or the existence of a vertical line between words within the line. Other values might be fluent or undetermined. (b) Column number: 2.
(4) String type: ddd.DD which means, a number with two figures right to a decimal point.
(5) Logical meaning: the logical meaning of a key data may be determined by a system, such as computerized-system 100, which may be implementing a method, such as computerized-method 200 in FIGS. 2A-2B, after detecting the category, e.g., document type, and the type of key data that should be looked for in the detected document type. When a word e.g., data field, is not one of the expected key data of the document type it may be determined as ‘general’. Thus, providing a logical meaning to each data field by linking each data field to a key data. Each key data may be validated by matching features of each data field ascribed to the one or more key data to corresponding recognized features of one or more data fields which are ascribed to same key data in the assigned group of look-alike documents. For example, a key data, may be ITEM_UNIT_PRICE. In cases that a value of a key data includes more than one word, such as the key data ITEM_DESCRIPTION, e.g., ‘skim milk 1%’, so each one of the consecutive data fields ‘skim’ and ‘milk’ and ‘1%’ may be ascribed to the same key data, hence to the logical meaning of each such data field will be added the prefix ‘part of’. For example, the logical meaning of each of the data fields ‘skim’ and ‘milk’ and ‘1%’ may be ‘part of ITEM_DESCRIPTION’.

According to some embodiments of the present disclosure, the output of the textographic analysis, may include a description of the document layout. The description of the document layout may comprise a list of records. The list of records may comprise records which have been identified as related to an author from which the document has been received, a recipient e.g., addressee and related to a determined category, e.g., document type.

According to some embodiments of the present disclosure, the list of records may include records which may visually distinguish the analyzed document from other document types. For example:
(1) Page header—there may be a record per each page of the document:
   (a) Location:
      1) page number e.g.: ‘1’. 2) distance of the left side of the “virtual rectangle”, bounding the whole page header, from the left edge of the page, e.g., 10 mm. 3) distance of the top of the “virtual rectangle”, bounding the whole page header, from the top edge of the page, e.g., 9 mm.
   (b) Dimensions: 1) page header width e.g., 195 mm. 2) page header height e.g., 30 mm.
   (c) Images within the boundaries of the page header—the images within the boundaries of a page header may commonly be a company logo. For example,
      1) image number, e.g., ‘1’. 2) distance of the left side of the “virtual rectangle”, bounding the relevant image, from the left edge of the page, e.g., 15 mm). 3) distance of the top of the “virtual rectangle”, bounding the relevant image, from the top edge of the page, e.g. 9 mm. 4) image width, e.g., 50 mm. 5) image Height, e.g., 25 mm.
   (d) Text lines within the boundaries of the page header—the text lines within the boundaries of the page header may commonly be author details. For example,
      1) number of text lines, e.g., ‘2’. 2) maximal text line length, e.g., 160 mm. 3) average text line height e.g., 3.8 mm. 4) gap between consecutive text lines of page header, e.g., 2 mm. 5) average character width in page header e.g., 2.9 mm. 6) average space between words in page header, e.g., 2.5 mm.
(2) Page footer—there may be a record per each page of the document. For example,
   (a) Location:
      1) page number, e.g., ‘1).’ 2) distance of the left side of the “virtual rectangle”, bounding the whole page footer, from the left edge of the page, e.g., 10 mm. 3) distance of the top of the “virtual rectangle”, bounding the whole page footer, from the top edge of the page, e.g., 9 mm.
   (b) Dimensions:
      1) Page footer width, e.g., 195 mm. 2) Page footer height, e.g., 30 mm.
   (c) Images within the boundaries of a page footer—the images within the boundaries of a page footer may commonly be a company logo. For example,
      1) image number e.g., ‘1’. 2) distance of the left side of the “virtual rectangle”, bounding the relevant image, from the left edge of the page e.g., 15 mm. 3) distance of the top of the “virtual rectangle”, bounding the relevant image, from the top edge of the page e.g., 9 mm. 4) image width e.g., 50 mm. 5) image height e.g., 25 mm.
   (d) Text lines within the boundaries of the page footer—the text lines within the boundaries of the page footer may commonly be author details, For Example,
      1) number of text lines, e.g., ‘2’. 2) maximal text line length e.g., 160 mm. 3) average text line height, e.g., 3.8 mm. 4) gap between consecutive text lines of page footer, e.g., 2 mm. 5) average character width in page footer, e.g., 2.9 mm. 6) average space between words in page footer, e.g., 2.5 mm.
(3) Document subject, for example,
   (a) Subject location:
      1) line number, e.g.: ‘7’. 2) gap between subject line and the text line which precedes it, e.g., 20 mm. 3) distance from the left edge of the page to the left side of the subject, e.g., 18 mm. 4) distance from the top of the page to the top of the subject, e.g., 90 mm.
   (b) Subject graphical characteristics, for example,
      1) font type, e.g., ‘Times New Roman bold’. 2) font Size, e.g., ‘18’. 3) width of the “virtual rectangle” which bounds the subject e.g., 120 mm. 4) height of the “virtual rectangle” which bounds the subject, e.g., 5 mm. 5) average character width in the subject, e.g., 4.7 mm. 6) underline beneath the subject, e.g., ‘YES’.
(4) Chapters and paragraphs—there may be a separate record per each chapter or paragraph. For example,
   (a) Chapter or paragraph header:
      1) Text justification within line, e.g., LEFT or RIGHT or CENTERED or ALIGNED. 2) Data Field type, e.g., ENGLISH_CAPITAL_LETTERS. 3) Distance from the left edge of the page to the left edge of the header, e.g., 60 mm. or VARIABLE. 4) Width of the “virtual rectangle” which bounds the header, e.g., 85 mm. or VARIABLE. 5) Height of the “virtual rectangle” which bounds the header, e.g., 6 mm. 6) header numbering method e.g., 1.1. 1.2. 1.3. or: I. II. III. or: (A). (B). (C). etc. 7) Header numbering font type e.g., Times New Roman bold. 8) Header numbering font size, e.g., 16. 9) Header font type, e.g., Times New Roman bold. 10) Header font size, e.g., 16. 11) Average character width in the header, e.g., 4.7 mm. 12) Average space between words in the header, e.g., 2.8 mm. 13) Minimal gap between the header line and the text line which precedes it, e.g., 15 mm. 14) Minimal gap between the header line and the text line which follows it, e.g., 7 mm. 15) Underline beneath the header, e.g., ‘YES’.
   (b) Paragraphs within the chapter:
      (b.1) Paragraph header:
      1) Text justification within line, e.g., LEFT or RIGHT or CENTERED or ALIGNED. 2) Data field type, e.g., ENGLISH_TEXT. 3) Distance from the left edge of the page to the left edge of the header, e.g., 40 mm. 4) Width of the “virtual rectangle” which bounds the header, e.g., 125 mm. 5) Height of the “virtual rectangle” which bounds the header, e.g., 6 mm.). 6) Header numbering, e.g., NO or: 1.1. 1.2. 1.3. or: 1.a. 1.b. 1.c. or: A. B. C. etc. 7) Header numbering font type, e.g., Times New Roman. 8) Header numbering font size, e.g., 16. 9) Header font type, e.g., Times New Roman bold. 10) Header font size, e.g., 16. 11) Average character width in the header, e.g., 4.7 mm. 12) Average space between words in the header, e.g., 2.8 mm. 13) Minimal gap between the header line and the text line which precedes it, e.g., 14 mm. 14) Minimal gap between the header line and the text line which follows it, e.g., 6 mm. 15) Underline beneath the header, e.g., NO.
      (b.2) Text lines within a paragraph:
      1) Text justification within line, e.g., LEFT or RIGHT or CENTERED or ALIGNED. 2) Paragraph numbering, e.g., NO or: [001] [002] [003] or: 1.a. 1.b. 1.c. etc. 3) Paragraph numbering font type, e.g., Times New Roman bold. 4) Paragraph numbering font size e.g., 12. 5) Distance from the left edge of the page to the leftmost edge of paragraph numbering, e.g., 10 mm. 6) Width of the “virtual rectangle” which bounds the paragraph numbering, e.g., 16 mm. 7) Distance from the left edge of the page to the leftmost edge of paragraph text lines, e.g., 10 mm. 8) Width of the “virtual rectangle” which bounds the longest text line, e.g., 190 mm. 9) Height of the “virtual rectangle” which bounds the highest text line, e.g., 4 mm. 10) Average gap between two consecutive lines within the paragraph, e.g., 4 mm. 11) Dominant font type in the paragraph, e.g., Times New Roman. 12) Dominant font size in the paragraph, e.g., 12. 13) Average character width in the paragraph, e.g., 2.8 mm. 14) Average space between words in the paragraph, e.g., 2.1 mm.
(5) Vertical and horizontal lines—there may be a separate record for each line within the analyzed document. For example,
   a) Vertical lines
      1) page number, e.g., ‘1).’ 2) distance from the left side of the line to the left edge of the page, e.g., 10 mm. 3) distance from the top edge of the line to the top edge of the page e.g., 112 mm. 4) line width, e.g., 0.5 mm. 5) line length, e.g., 165 mm.
   b) Horizontal lines
      1) page number, e.g., ‘1).’ 2) distance from the left edge of the line to the left edge of the page, e.g., 10 mm. 3) distance from the top edge of the line to the top edge of the page, e.g., 123 mm. 4) line length e.g., 193 mm. 5) line height, e.g., 0.5 mm.
(6) Tables—there may be a separate record for each tabular structure within the document. For example,
   (a) Table boundaries:
      1) table current number, e.g., ‘1).’ 2) gap between the top edge of the table and the text line which precedes it, e.g., 19 mm. 3) distance of the left side of the table from the edge of the page, e.g., 10 mm). 4) distance of the top of the table from the top edge of the page e.g., 112 mm). 5) distance from the top of the table to the top of the first row of data within the columns of the table, e.g., 52 mm. 6) table width e.g., 193 mm. 7) table height e.g., 165 mm.
   (b) Table header—when there is a table header, it may include for example,
      1) header contents e.g., ‘final votes for competing songs in Eurovision contest 2018’. 2) header font type, e.g., ‘Times New Roman bold’. 3) font Size, e.g., ‘14’. 4) width of the “virtual rectangle” which bounds the header, e.g., 105 mm. 5) height of the “virtual rectangle” which bounds the header, e.g., 5.5 mm. 6) average character width in the header, e.g., 4.4 mm. 7) average space between words in the header, e.g., 2.7 mm. 8) underline beneath the header, e.g., ‘NO’.
   (c) Column structure—there may be a separate record for each column within the table. For example,
      (b.1.) Column boundaries—column boundaries may include a column header. For example,
      1) column number, e.g., ‘2):’ 2) distance between the left boundary of the table and the left boundary of the relevant column, e.g., ‘40’. 3) distance between the top edge of the column, including column header, to the top of the relevant page, e.g., 69 mm. 4) column width, e.g., 23 mm. 5) column height, including column header, e.g., 140 mm. 6) vertical lines bound each column, e.g., ‘YES’.
      (b.2.) Column header—when there is a column header it may include for example,
      1) column header contents, e.g., ‘Name of competing song’. 2) column header height, e.g., 30 mm. 3) column header font type, e.g., ‘Times New Roman bold’. 4) column header font Size, e.g., ‘14)’. 5) average character width within the header e.g., 4.5 mm.
      (b.3.) Data fields within the column—data fields within the column may include for example,
      1) font type, e.g., ‘Times New Roman’. 2) font Size, e.g., ‘12’. 3) data field type, e.g., ENGLISH_TEXT. 4) distance between the top edge of the “virtual rectangle” which bounds the first data field within the column, to the top of the relevant page, e.g., 129 mm. 5) average character width in relevant data fields, e.g., 2.6 mm. 6) average character width: 2 mm. 7) minimal vertical distance between the bottom and the top of two consecutive data fields within the same column, e.g., 3 mm. 8) horizontal lines bound each column, e.g., ‘YES’.

According to some embodiments of the present disclosure, a system such as computerized-system 100 may for classifying a document and detecting and validating key data within the document may receive a stream of uniform format documents, such as stream 130. For each document in the stream of uniform format documents. The stream may be any stream of documents, e.g., in a uniform PDF standard, after conversion of any image into readable text, by an OCR module.

According to some embodiments of the present disclosure, the results of the textographic analysis module, such as textographic analysis module 140, may be saved into a data storage, such as data storage 150, that is stored in memory, such as memory 160. Furthermore, the textographic analysis module, such as textographic analysis module 140, may (a) determine a category, an author and recipient of each document by: (i) extracting features of the document and features of one or more data field within it; and (ii) comparing the extracted features to prestored characteristics of one or more categories of documents in the data storage; (b) detect one or more key data, based on the determined category to ascribe each detected key data to corresponding one or more data fields within the document

According to some embodiments of the present disclosure, after the operation of a textographic analysis, the processor, such as processor 110 may be configured to operate a textographic learning module, such as textographic learning module 120. The textographic learning module, such as textographic learning module 120, may be operated on the received stream of uniform format documents, such as stream 130 to: (a) sort documents in stream of uniform format documents into groups of look-alike documents (b) store in a data storage the extracted features of the one or more data fields for the ascribed key data, for each group of look-alike documents; and (c) assign each document in the stream of uniform format documents to a group of look-alike documents and store the assignment of each document in the data storage.

According to some embodiments of the present disclosure, the sort documents in stream of uniform format documents into groups of look-alike documents may include detecting common features of documents having the same category, author and recipient.

According to some embodiments of the present disclosure, it is assumed that commonly there will be found similarity in the general structure of documents and in the location and format of each key data field which are received from the same author and should be classified to the same category. Such documents are referred to as look-alike documents.

Furthermore, commonly documents of the same type which were created by the same author and addressed to the same recipient were produced by the same computer software. For example, financial management software, such as Elite accounting software. Accordingly, it is assumed that these documents may have the same document structure and may use similar column structure. Also, key data elements may be found in similar locations in the document, with specific keywords in their vicinity, and have the same format and the same font type. All related documents of look-alike documents may include the same language and the same vocabulary of words and phrases.

According to some embodiments of the present disclosure, saving the relevant location and font of each data field, may be used by an error-correction model and assist whenever an uncertain recognition is detected, thus a higher accuracy OCR process may be implemented on the image of the document at the specific location, while knowing the expected font and data format of a specific string, such as a word or a number.

According to some embodiments of the present disclosure, an error-correction model may correct many of the previous recognized words having errors. Accordingly, the textographic analysis module 140 and the computerized-method for classifying any document, including scanned paper-documents, such as computerized-method 200 in FIGS. 2A-2B for classifying documents and detecting and validating key data within the document, may enable understanding of the context of each data field and further validate or correct any OCR error in received scanned paper-document, accordingly.

According to some embodiments of the present disclosure, a textographic learning module, such as textographic learning module 120, may receive a preconfigured number of samples of documents which are related to a group of look-alike documents, to identify common features in the documents of the group of look-alike documents and to recognize patterns for each data field, in each document and location of a key data. This may be an iterative process in which each time the textographic learning module, such as textographic learning module 120, may receive documents which are related in each iteration to a different group of look-alike documents.

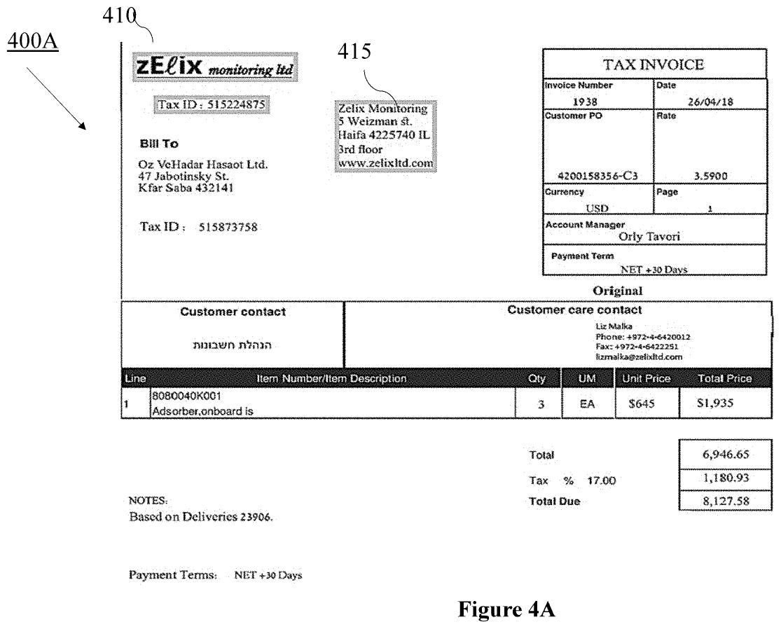

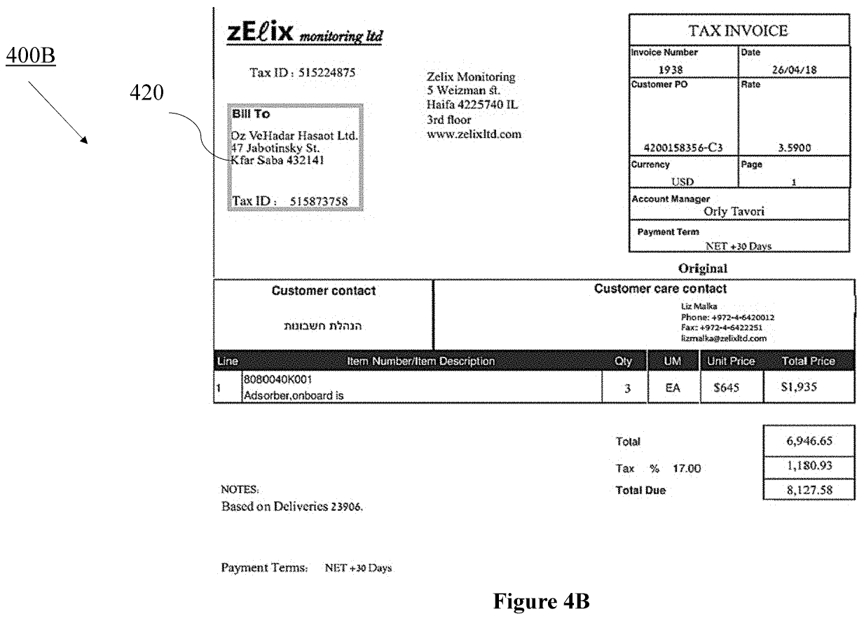

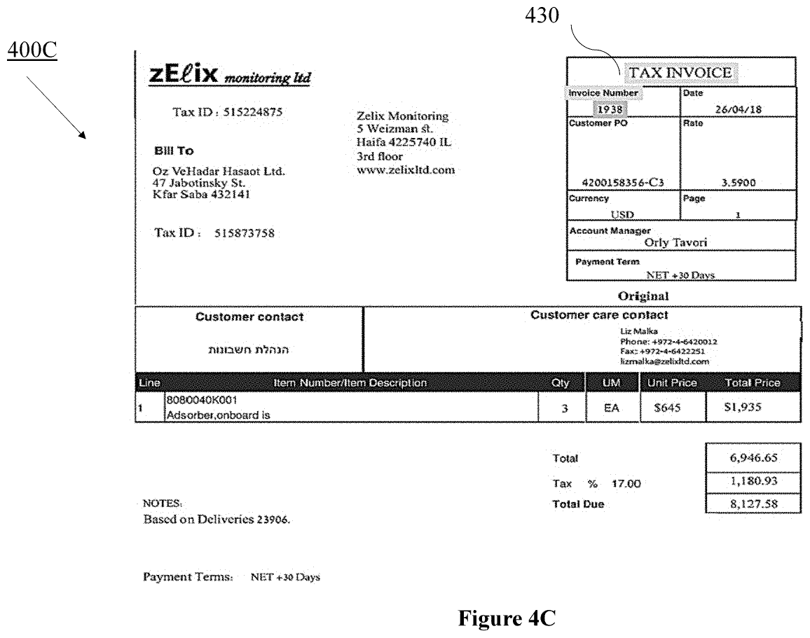

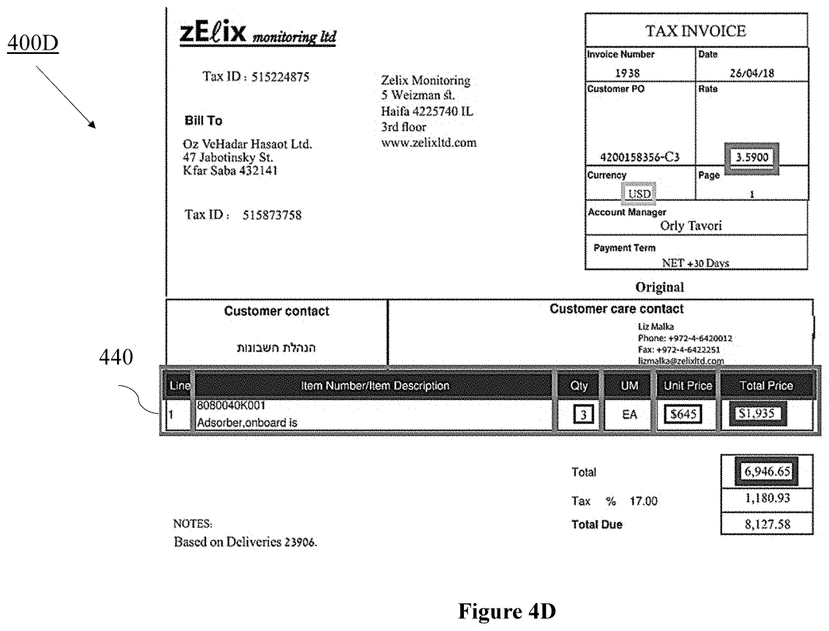

According to some embodiments of the present disclosure, the textographic learning module, such as textographic learning module 120, may identify similarities in each received group of preconfigured number of samples of documents and assign them to the same group of look-alike documents. For example, each group of look-alike documents may have the same visual layout, e.g., the same column structure, page headers and footers, location of vertical lines, line lengths and heights, vertical gaps between text-lines, typical fonts and spacing, vertical gaps between text lines, location of vertical and horizontal lines, paragraphs and columns structure, and the like, as shown in examples 400A-400D in corresponding FIGS. 4A-4D.

According to some embodiments of the present disclosure, vertical same color lines enable distinction between columns within tabular structures. Horizontal same color lines enable distinction between items details within tabular structures or underlined words or phrases, such as document-subject or chapter header etc.

According to some embodiments of the present disclosure, the visual layout may also include the format and location of each data field in each page of a document. Also, key data fields in each group of these look-alike documents, such as document date, items prices, item descriptions, etc., are often located in similar horizontal locations, having the same format, i.e., the same combination of characters, size, font, keywords in its vicinity or in the relevant column header, etc.

According to some embodiments of the present disclosure, page header and footer, if they exist, are specific templates, which are detected by the fact that they appear in fixed locations at the top and bottom of the first page of each document or even on every page.

According to some embodiments of the present disclosure, the header and footer commonly include a few lines, which might be separated from the rest of the text-lines, by a horizontal black-line or by a vertical white gap, which clearly exceeds the vertical gap between the text-lines within the page header and footer. Otherwise, the horizontal coordinate of the right edge of each text-lines in the header or footer may exceed the maximal right-edge coordinate of the rest of the text-lines in the page. Or, the minimal left-edge horizontal coordinate of the rest of the text-lines in the page may exceed the horizontal coordinate of the left edge of every text-line in the header of footer exceed. Or, the font type and size in the header and footer may be clearly distinguishable from the font type and size of other text-lines in the document.

According to some embodiments of the present disclosure, the header and footer may be considered to identify the document author and may typically include a logo, company name, company number, address, phone number, website, etc. Comparing these data fields to a known list of relevant document authors may enable validation and even error correction, whenever a slight misrecognition occurs.

According to some embodiments of the present disclosure, repetitive headers and footers may be confidently detected and saved to the relevant knowledge base, by comparing the image of previous analyzed documents which are stored in a data storage, such as data storage 150 as assigned to a group of look-alike documents i.e., of the same type and from the same author and the same addressee, as by element 410 in FIG. 4A.

According to some embodiments of the present disclosure, the textographic learning module, such as textographic learning module 120, may search for key data fields which their values have a common pattern. For example, in each document, in a group of look-alike documents, an item-unit-price data field, may be located at the third column of the detailed items table, about 112 mm or 4.4 inches from a left edge of a page, printed in font “Courier—size 12”, with two digits right to the decimal point, while the range of prices is up to several tens of dollars.

According to some embodiments of the present disclosure, the textographic learning module, such as textographic learning module 120, may search the location and format, as well as the pattern of each data field, in each document in the received sample of documents, which are assigned to a group of look-alike documents.

For example, several catalog numbers or logos, with similar structure, may be found on various pages in a document, or alternately, in the same group of look-alike documents. For example, by the following document reference numbers in the same group of look-alike documents: ‘AR-177235/2020’, ‘AR-178074/2020’, ‘AR-178392/2020’, ‘AR-179141/2020’—the “textographic learning” module, such as textographic learning module 120, may determine that the pattern of a data field such as document reference numbers may be: AR-NNNNNN/YYYY, where ‘AR’ is constant, ‘NNNNNN’ is for numeric characters and ‘YYYY’ is for the year.

According to some embodiments of the present disclosure, the textographic learning module, such as textographic learning module 120, may store in a data storage, such as data storage 150, detected visual structure and location, format and pattern of each data field within each group of look-alike documents, and also detected finite number of words and phrases, which are used in each group of received look-alike documents.

According to some embodiments of the present disclosure, before a textographic analysis on any stream of documents, scanned-paper documents are detected, as they are received as “images”, which were converted to text by an OCR-process and may include OCR errors. Each scanned document may be processed, to enhance an image of each scanned and photographed page in each document and to remove noise in each scanned document, including de-skewing of tilted images, by using standard software modules, which are commonly used in image processing. For example, color and grayscale images may be converted to binary images, using dynamic thresholding; implementing de-speckling and noise removal; and curved-lines alignment, image de-skew and “rectanglization” of tilted images.

According to some embodiments of the present disclosure, before the textographic analysis, which may be operated by textographic analysis module 140, each scanned document in the stream of documents 130, may be further resized to a fixed size after removing any margins, added by an improper or skewed scanning or by a photography of the original document, which may affect the location of key data in look-alike documents. For example, automatically resizing different image sizes to a standard size, e.g.: A4 paper size. The fixed size of the page with unified margins may enable to detect similar structures and patterns, in similar locations, within previously analyzed documents, by a textographic learning module, such as textographic learning module 120, and stored in a data storage, such as data storage 150 documents of the same type which were generated by the same author and are addressed to the same recipient.

According to some embodiments of the present disclosure, before the textographic analysis, which may be operated by textographic analysis module 140, each document in the stream of documents 130, may be further converted to a standard searchable file format, such as Portable Document Format (PDF) file format, which includes the image of each page, as well as related text and its attributes e.g., font type and size and the exact coordinates of each character or word within the page, which is written as a “hidden layer” under the page image.

According to some embodiments of the present disclosure, when the original document has been scanned or photographed, then a “hidden layer” of the text and its attributes may be previously created by an OCR software, with possible errors in the recognized words. The OCR software may also orient any flipped or landscaped page and may determine the direction of the language of the text in the document e.g., “left to right”, as in English, and other Romance languages or “right to left”, as in Hebrew or Arabic and other Semitic languages.

According to some embodiments of the present disclosure, a textographic analysis module, such as textographic analysis module 140, may validate each determined key data in each document, in the stream of uniform format documents, by matching features of each data field ascribed to the one or more key data to corresponding recognized features of one or more data fields which are ascribed to same key data in the assigned group of look-alike documents and stored in data storage 150.

According to some embodiments of the present disclosure, upon mismatches in a comparison of an analyzed document from the stream of scanned documents 130 or any data field within it to documents in the data storage, such as data storage 150, the textographic learning module, such as textographic learning module 120, may determine that the analyzed document may be classified into a new group of look-alike documents. However, the mismatch may be due to a premeditated change, which has been performed by an author of the analyzed document.

According to some embodiments of the present disclosure, when the textographic learning module, such as textographic learning module 120, may receive an indication that the analyzed document has been preprocessed by an OCR software before the classification, the textographic learning module, such as textographic learning module 120, may operate an error-correction module to correct one or more data fields that were not matched to any data fields in the analyzed document.

According to some embodiments of the present disclosure, the error-correction module may operate a higher accuracy OCR process on the image at the specific location of the one or more data fields that were not matched to any data fields in the analyzed document, while the font and data format of the specific values of the data fields are known from other data fields which were recognized and matched in the analyzed document.

According to some embodiments of the present disclosure, the textographic analysis module, such as textographic analysis module 140, may also operate the error-correction model to correct one or more data fields that were not matched to any data fields in the analyzed document i.e., based on the validation of key data.

According to some embodiments of the present disclosure, textographic analysis module, such as textographic analysis module 140, may further check validity of every word or data field within an analyzed document to detect errors, by: (i) searching the word or value of each data field of the analyzed document, in the detected finite number of words and phrases, e.g., relevant vocabulary; (ii) comparing the pattern of each word or value of each data field to the determined pattern in the determined specific location.

According to some embodiments of the present disclosure, the detected finite number of words and phrases, e.g., relevant vocabulary, may be stored in a data storage, such as data storage 150. Furthermore, the detected finite number of words and phrases may have been stored in the data storage, such as data storage 150 by the textographic learning module, such as textographic learning module 120, when samples of documents which are related to look-alike documents were provided to it for analysis.

According to some embodiments of the present disclosure, for example, a string ‘103.7’ might be validated or corrected by the textographic analysis module, such as textographic analysis module 140, as follows: if a paragraph-number is expected in related horizontal coordinates, then the operated error-correction model may search for ascending paragraph numbers and accordingly validate or correct the string ‘103.7’.

According to some embodiments of the present disclosure, if an item-catalog-number is expected in this location, then the string ‘103.7’ may be validated against documents in the data storage, such as data storage 150, which are having catalog numbers of previously ordered or supplied items from the same vendor. However, if the expected data field type in the location is an item-total-price, then the string ‘103.7’ might be validated by a multiplication of the relevant item-unit-price and item-quantity or also by summing the value of the data fields which were classified as item-total-price, into a grand-total, which may be expected to be found in the analyzed document.

According to some embodiments of the present disclosure, when the textographic analysis module, such as textographic analysis module 140, may not find such grand-total, the error-correction model may look for a probable misrecognized or even missing item-total-price in a related column, by examining any vertical gap between consecutive item-total-price data elements, which significantly exceed the average vertical distance between consecutive item-total-price data elements.

According to some embodiments of the present disclosure, the textographic analysis module, such as textographic analysis module 140, may iteratively operate a different OCR software than the OCR software that has been operated on these specific locations and amendments may be checked as suitable corrections, till all item-total-price data elements may be summed up correctly.

According to some embodiments of the present disclosure, the textographic analysis module, such as textographic analysis module 140, may be operating a detection and error-correction model to any data field within the analyzed document. The textographic analysis module, such as textographic analysis module 140, may detect one or more key data, based on the determined category to ascribe each detected key data to corresponding one or more data fields within the document.

According to some embodiments of the present disclosure, the textographic analysis module, such as textographic analysis module 140, may further compare a structure and context of each data field with a predefined list of properties of key data types and the expected one or more keywords in the vicinity of the key data, in the analyzed document, according to the analyzed document type to detect key data.

According to some embodiments of the present disclosure, the properties of key data types and the expected one or more keywords near the key data are determined by the textographic learning module, such as textographic learning module 120, during the process of identifying common features, i.e. attributes, in the documents of the group of look-alike documents and to recognize patterns for each data field, in each document and location of a key data in the iterative process of receiving a preconfigured number of samples of documents which are related to a group of look-alike documents.

According to some embodiments of the present disclosure, an implementation of the textographic analysis module, such as textographic analysis module 140, on a large variety of commercial and financial documents, such as invoices, purchase orders, shipment documents, insurance policies, bank account reports and the like has yielded that from a batch of about 10K documents, approximately 97% were successfully classified and auto-corrected and all related key data was properly extracted, without any human intervention. Which means that only about 3% of the documents still needed human intervention to verify uncertain key data. The results of approximately 97% of the documents being classified and auto-corrected, may be compared to existing technologies in the market today, in which typically about 35% of the documents requires human intervention for key data verification.

FIGS. 2A-2B are a high-level workflow of a computerized-method 200 for classifying a document and detecting and validating key data within the document, in accordance with some embodiments of the present disclosure.

According to some embodiments of the present disclosure, the computerized-method 200 may classify each input document, after converting it into a standard searchable PDF, while any scanned paper-document may be pre-processed to enhance the relevant image of each page, and afterwards apply a standard OCR process, which converts each scanned paper-document to a standard PDF file, which preserves the image of each page, as well as the detected text within each document.

According to some embodiments of the present disclosure, operation 210 may comprise receiving a stream of uniform format documents, for each document in the stream of uniform format documents, operating a textographic analysis module to: (a) determine a category, an author and recipient of each document by: (i) extracting features of the document and features of one or more data field within it; and (ii) comparing the extracted features to prestored characteristics of one or more categories of documents in the data storage; (b) detect one or more key data, based on the determined category to ascribe each detected key data to corresponding one or more data fields within the document.

According to some embodiments of the present disclosure, the extracting features of the document and features of one or more data fields within it, may further include repetitive pattern detection within the same document.

According to some embodiments of the present disclosure, the received stream of uniform format documents may include other types of computerized documents. For example, documents in the received stream of uniform format documents may have been received as paper-documents which were then scanned or photographed to enable a computerized processing. Such scanned paper-documents may be automatically pre-processed to enhance an image of each scanned or photographed page in each document and to remove noise in each scanned document, as detailed above.

According to some embodiments of the present disclosure, the image of each page in the scanned paper-document may be further resized to a preconfigured uniform size, and the text within each image may be automatically recognized, by an OCR process. The document may be further converted to a standard uniform text-searchable format, similar to the format of any other non-scanned digital document, which might be, for instance, a text-searchable Portable Document Format (PDF).

According to some embodiments of the present disclosure, operation 210 may be performed by receiving a stream of PDF documents and operating a textographic analysis module for detecting: (i) the layout and language of the relevant document, including the specific structure of chapters, paragraphs, line lengths and line spacing, and the location and width of every column within tabular structures; and (ii) the graphical and textual characteristics of every word within the document, including its location, font type and size and the data type of the relevant text. For example, a date with a format DD/MM/YYYY, a number with two figures right to the decimal point, English capital letters etc.

According to some embodiments of the present disclosure, a module, such as textographic analysis module operated by computerized-method 200, may be operating based on detection of relevant keywords within the document, mainly within the document subject or within paragraph headlines. The relevant keywords may be preconfigured and stored as a list in a data storage, such as data storage 150 in FIG. 1. Each list may be in a different language. Each list may indicate a relevant document type. For example, “Invoice number”, “Invoice No.”, “Invoice #” etc., or similar keywords in other languages, followed by the invoice number may indicate that the document-type is an invoice. In another example, “Receipt number”, “Receipt No.”, “Receipt #” etc., or similar keywords in other languages may indicate that the relevant document-type is a receipt.

According to some embodiments of the present disclosure, a module, such as textographic analysis module operated by computerized-method 200, may not look for an exact match, but for a fuzzy match to the above keywords. For example, “lvolce” or “involco” may be matched with “invoice”. Hence, whenever a match occurs any misrecognized text may be also automatically corrected, according to the proper spelling.

According to some embodiments of the present disclosure, when no match has been found to any of the preconfigured lists of words, or to any document in any group of look-alike documents, which are stored in the data storage, such as data storage 150, in FIG. 1, it may indicate that the document may be classified as general document type.

According to some embodiments of the present disclosure each received document may be classified to a different queue of documents to be processed, according to its author and recipient and according to its specific document type, e.g. lawsuit, vehicle insurance policy, invoice, purchase order, etc. The document author, document recipient and document type are all detected as a result of the textographic analysis, among other key data, as described in a module for the extracting features of the document and of each data field within the document. Undetermined document types are transmitted to be classified by a human, before applying the next automated process.

According to some embodiments of the present disclosure, operation 220 may comprise operating a textographic-learning module on the received stream of uniform format documents to: (a) sort documents in stream of uniform format documents into groups of look-alike documents (b) store in a data storage the extracted features of the one or more data fields for the ascribed key data, for each group of look-alike documents; and (c) assign each document in the stream of uniform format documents to a group of look-alike documents and store the assignment of each document in the data storage.

According to some embodiments of the present disclosure, when there are documents in the stream of uniform format documents, such as stream 130 in FIG. 1, which are related to a new category of documents that its characteristics are not in the data storage, human intervention is required to define the new category and its characteristics.

According to some embodiments of the present disclosure, operation 230 may comprise validating each determined key data in each document, in the stream of uniform format documents, by matching features of each data field ascribed to the one or more key data to corresponding recognized features of one or more data fields which are ascribed to same key data in the assigned group of look-alike documents.

According to some embodiments of the present disclosure, unvalidated key data may require human intervention. The corrected unvalidated key data may be automatically learned and ascribed to features of corresponding data fields.

According to some embodiments of the present disclosure, the validating of each determined key data in each document, in the stream of uniform format documents, may be performed by matching features of each data field ascribed to the one or more key data to corresponding recognized features of one or more data fields which are ascribed to same key data in the assigned group of look-alike documents and an OCR-errors correction process may be operated based on the validation.

According to some embodiments of the present disclosure, operation 230 may be performed by previously applying a textographic-learning module, which assumes that a queue of documents of the same type and from the same author and addressed to the same recipient—might be created by the same computer software, and hence might have similar layout, use similar fonts, use the same pattern of the document reference number, use similar table structures and the key data might be found in similar horizontal coordinates, with similar graphic characteristics etc. Accordingly, the textographic-learning module will analyze the documents from each such queue of documents to: (i) detect groups of documents, having the same layout, the same language, the same column structure, and the same graphical and textual characteristics; (ii) save the determined common features, including the recognized patterns and locations for each data field within each such group of documents, called look-alike document, into a data storage; (iii) detect repetitive words or phrases within the relevant group of look-alike document, including their graphical characteristics and location and save them into a relevant data storage; (iv) match the textographic analysis of each new processed document to the common features of a relevant group of look-alike documents, found in the data storage, or, else, determine that the document belongs to a new group of look-alike documents, which will need human intervention to verify the automatically detected key data and will need further learning when more similarly structured documents will be received; (v) detect all relevant key data, according to the specific type of the analyzed document. (vi) automatically validate the extracted key data and correct OCR-errors, if exist, by matching to expected characteristics and location in similar look-alike documents, and by relevant arithmetic computations on numeric data.

According to some embodiments of the present disclosure, operation 240 may comprise displaying via a display unit, the category, author, recipient and the validated key data of each document in the stream of uniform format documents.

According to some embodiments of the present disclosure, a new document type may be received, and data fields may be verified by a human to be saved in a data storage. The data storage may be a data storage such as data storage 150 in FIG. 1. Unverified extracted key data may be displayed for human verification and, updating the relevant data storage, accordingly, with the verified key data location, contents and characteristics.

According to some embodiments of the present disclosure, textographic-learning module may include OCR errors correction.

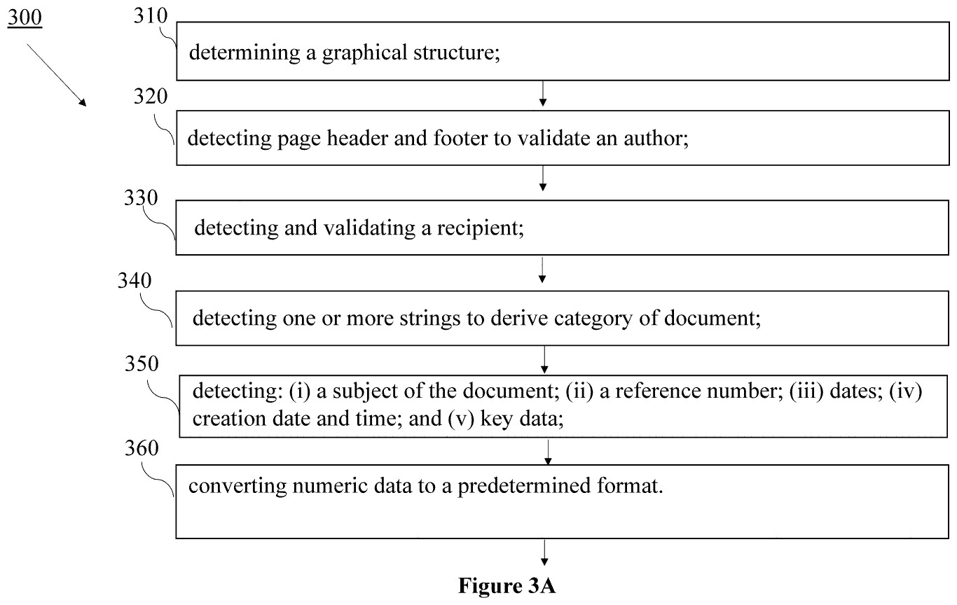

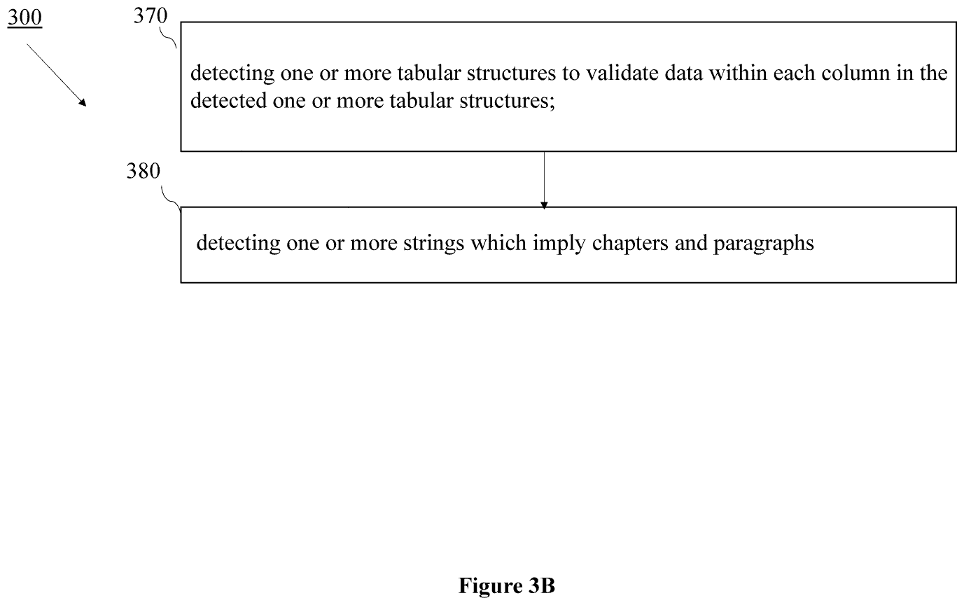

FIGS. 3A-3B are a high-level workflow of extracting features of the document and of each data field within the document 300, in accordance with some embodiments of the present disclosure.

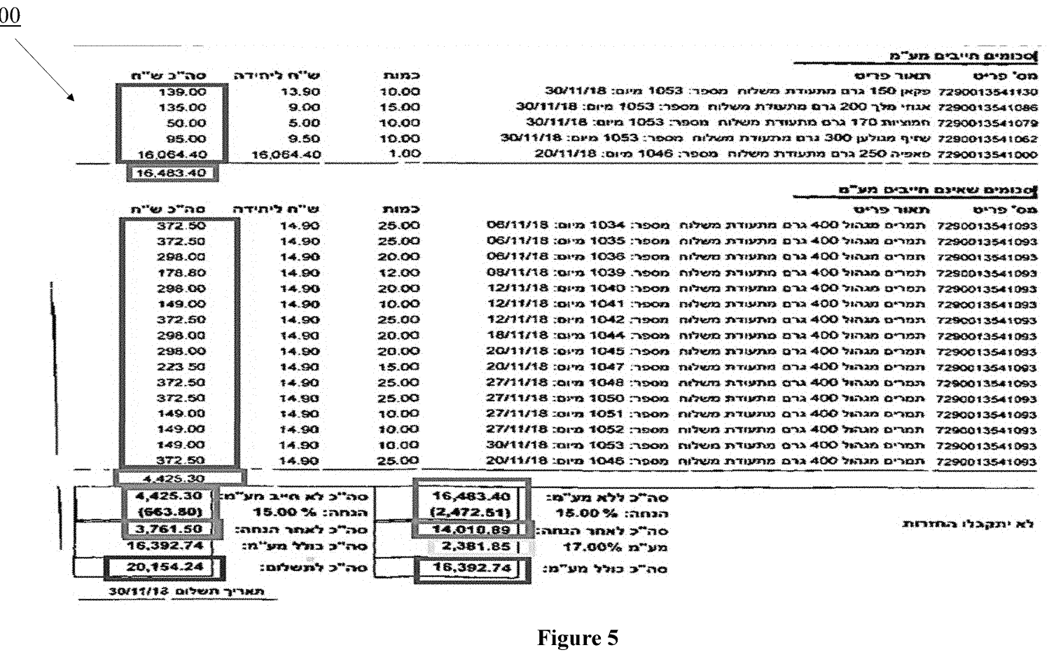

According to some embodiments of the present disclosure, operation 310 may comprise determining a graphical structure. For example, as shown in examples 400A-400D in FIGS. 4A-4D and examples 500-700 in FIGS. 5-7.

According to some embodiments of the present disclosure, operation 320 may comprise detecting page header and footer to validate an author. For example, element 410, in example 400A, FIG. 4A.

According to some embodiments of the present disclosure, operation 330 may comprise detecting and validating a recipient. For example, element 420, in example 400B in FIG. 4B.

According to some embodiments of the present disclosure, the recipient may be detected within the text-lines following the document header, if exists. It may be validated against a list of expected addressees, i.e. recipient, and their known details. A fuzzy match to one of the expected addressees may enable error-correction of any misrecognized characters in the detected document-addressee details by an error-correction module. For example, element 420, in example 400B in FIG. 4B.

According to some embodiments of the present disclosure, it may be assumed that the document author will usually use the same template, while printing the document-addressee in following look-alike documents. The recognized template may be saved to a data storage, such as data storage 150 in FIG. 1, to enable future detection of a similar template, which may imply the same document-addressee.

According to some embodiments of the present disclosure, operation 340 may comprise detecting one or more strings to derive category of the document. For example: tax invoice, lawsuit, purchase order, and the like.

According to some embodiments of the present disclosure, a module, such as textographic analysis module of computerized method 200 in FIGS. 2A-2B, may look for additional information within the document that may confirm the classification of the document. For example, element 430 in FIG. 4C or document type “invoice”, may be confirmed by detecting a grand total, which equals the summation of all item-prices. The module, such as textographic analysis module of computerized method 200 in FIGS. 2A-2B, may analyze features of each document to determine the classification thereof, by comparing the analyzed features to features of documents in the data storage, such as data storage 150 in FIG. 1.

According to some embodiments of the present disclosure, operation 350 may comprise detecting: (i) a subject of the document; (ii) a reference number; (iii) dates; (iv) creation date and time and (v) key data.

According to some embodiments of the present disclosure, a module, such as textographic analysis module of computerized method 200 in FIGS. 2A-2B, may detect dates by looking for three adjacent strings, representing: day, month and year (not necessarily in this order). These strings are commonly separated by blanks or other delimiters, such as period, dash, slash, but may also appear without any separating delimiter, e.g.: 20200123 or 23JAN2020, meaning: January 23, 2020.

According to some embodiments of the present disclosure, the string representing the day, might be a one or two digits integer, in the rage 1 to 31, or an ordinal number in English, e.g.: 1^{st}, 2^{nd}, 3^{rd}, 4^{th} etc., or an ordinal number in another language e.g.: 1er or 1re, 2eme or 2e, 3eme or 3e, in French. The string representing the month may be a one- or two-digits integer, in the rage of 1 to 12, or the relevant month name (full name or an abbreviated format), in various languages. For example, JANUARY, JANVIER, ENERO, JAN, ENE, FEBRUARY, FEVRIER, FEBRERO, FEB, FEV etc. The string representing the year may be two digits or a four digits integer, in the expected range of the relevant years, e.g., 19 or 2019.

According to some embodiments of the present disclosure, the distinction between the day string and the month string might be unclear. For example, 5 Jul. 2019 might mean Jul. 5 2019, or might mean May 7 2019. If there are several dates in the same document and at least one of them is unambiguous, e.g., May 31, 2019, then all the other dates in the same document may be interpreted according to this pattern. Else, the country or city in the document-author address or the country-code in the telephone number, both found in the document header or footer, will imply the format of dates. For example, in Germany 5 Jul. 2019—means Jul. 5 2019, while in USA, it might mean May 7 2019.

According to some embodiments of the present disclosure, when there may be still insufficient information in the document itself to determine the proper format of the date, it may be automatically leaned from former documents of the same type from the same author, which are stored in a data storage, such as data storage 150 in FIG. 1.

According to some embodiments of the present disclosure, assuming that these former documents were prepared by the same software then, they are expected to have a similar structure. So, all dates may usually have the same horizontal coordinates. Hence, an error-correction model that may be operating artificial intelligence algorithms, may operate a re-OCR of any string which may be detected in these horizontal coordinates, which could be considered an improper recognition of a date. For example, IS.02.2820 may be rechecked and may be expected to be corrected to 15.02.2020.

According to some embodiments of the present disclosure, after validating all the dates in the document, their format and exact location may be saved to a data storage, such as data storage 150, assuming that dates in future documents of the same type from the same author may have the same format and may be located at about the same horizontal coordinates and will also be printed in the same font. For easier future retrieval, all the dates in the document may be also converted to a standard format, e.g.: DD.MM.YYYY.

According to some embodiments of the present disclosure, the document creation date and time may be an important keyword for a classification of any document. It may be usually located at the top of the first page of the document, typically below the page header, if exists. After locating and validating all the dates in a document, the first of which may be the document creation date and time. Also, it might be confirmed by finding, in its vicinity, keywords that imply that it is the document date, e.g., “Document date:”, if there are several possible dates.

Furthermore, the document-reference-number and document-creation-date in former documents of the same type from the same author and the same addressee i.e., recipient are expected to appear in similar coordinates and their values will probably be in an ascending order. If such an order is detected in the data storage, such as data storage 150 in FIG. 1, in which analysis results of former documents are stored, the document creation date and time may be further verified or corrected. For example, if the former relevant document was dated Jan. 15 2019, then, any date prior to it may be considered a faulty recognition. So, an alternate OCR process may be applied to properly correct the misrecognized date.

According to some embodiments of the present disclosure, once the document creation date may be confirmed, the module, such as textographic analysis module of computerized method 200 in FIGS. 2A-2B may look for the exact creation-time of the document. If exists, it will usually appear adjacent to the document-creation-date, in a format HH:MM:SS or HH:MM, the delimiter between the hours, minutes and seconds may not necessarily be a colon. E.g.: 13_07_25.

According to some embodiments of the present disclosure, the document-reference-number may be a unique identifier of the specific document. It may succeed the prefix “REF:” or the words describing the document type, e.g. “Purchase Order number”, “Bill Of Lading #”, “Invoice Number”, etc. (or similar keywords in other languages, according to a relevant pre-defined list of relevant keywords). In case that the document-reference-number was improperly recognized by an OCR software, an error-correction module may correct it by learning the expected pattern from former documents from the same author and of the same document-type. For example, if the document-reference-number in former documents were ACQ-0012306/2020, ACQ-0012497/2020, ACQ-0012688/2020, then the erroneous document-reference-number ACO-0012994/2820—will be properly corrected to ACQ-0012994/2020.

According to some embodiments of the present disclosure, the document subject, if exists may be searched in the upper half of the first page of the document, following the document header. It may be recognized by following the word “Subject:” or “RE:” or similar words in other languages, supplied in a predefined list of relevant keywords. Alternately, its font size might be bigger than the one used in the following text-lines within the same page, or else it might be printed in different font type (bold or italics) or sometimes underlined.

According to some embodiments of the present disclosure, the end of the document subject may be usually determined by the existence of an underline or a vertical gap, which exceeds the average vertical gap between consecutive text-lines in the same page. The words in the document-subject may be automatically checked by a relevant speller and dictionary, and also compared to the vocabulary automatically constructed from previously analyzed documents of the same type and from the same author and addressee.

According to some embodiments of the present disclosure, operation 360 may comprise converting numeric data to a predetermined format. The numeric data may be converted to the predetermined format to avoid ambiguities caused by different interpretations of the comma and period delimiters.

According to some embodiments of the present disclosure, operation 360 may comprise of prior conversion of numeric data to a predetermined format, because the same numeric field may have totally different interpretations in various languages. For example, 3,000 means three thousand in U.S.A., but in French documents it means only 3, because the comma is used to represent decimal places, rather than a period, used in the U.S.A. So, it is interpreted like 3.000 in the U.S.A. Therefore, to avoid any misinterpretation of such numeric data and to be able to activate relevant computations to validate such data or activate automatic error-corrections, relevant algorithms are applied to first determine the proper interpretation of every numeric field and save such data in a uniform format.

According to some embodiments of the present disclosure, to interpret prices and amounts within the document, the module, such as module of computerized method 200 in FIGS. 2A-2B for analyzing features of the relevant document may determine, for example, if the string ‘3'000’ or ‘3.000’ or ‘3,000’ actually represents three thousands or only 3 (with three places right to the decimal point, which are ‘000’), as might be interpreted in several countries.

According to some embodiments of the present disclosure, it is assumed that all the prices and amounts in the document should be interpreted in the same manner. So, the module, such as textographic analysis module of computerized method 200 in FIGS. 2A-2B and such as textographic analysis module 140 in FIG. 1, may look for at least two unambiguous amounts within the document, which may confirm the actual format of numeric data within the specific document. For example, ‘3,50’ and ‘2,25’ may be interpreted only as three and a half and three and a quarter, according to the Western European format. It may confirm that ambiguous amounts, like ‘3.000’, should be interpreted as three thousand.

According to some embodiments of the present disclosure, in case that no unambiguous amounts are detected within the document the interpretation of numeric data may be determined according to the country in which the document was created, which may be included in the author's address or implied by the country-code in the author's phone number.

According to some embodiments of the present disclosure, if no indication of the country is found within the document, the format of numeric data may be learned from former documents of the same type, which were composed by the same author. To enable standard computations, all the prices and amounts within the document may be converted to the standard format used in the U.S.A. For example, ‘3,50’ and ‘2,25’ may be converted to ‘3.50’ and ‘2.25’, accordingly.

According to some embodiments of the present disclosure, operation 370 may comprise detecting one or more tabular structures to validate data within each column in the detected one or more tabular structures. It may be operated according to the expected contents and structure of each data field in each location within the table and further validation of numeric data by relevant arithmetic computations. For example, as shown in element 440 in FIG. 4D.

According to some embodiments of the present disclosure, to detect the first text-line of a tabular structure, the module, such as textographic analysis module of computerized method 200 in FIGS. 2A-2B, may search the text-lines, following the page header, to find vertical same color lines e.g., black-color, which divide the words of in each text-line into separate columns.

According to some embodiments of the present disclosure—if no vertical same-color lines (e.g.: black-lines) exist, the module, such as textographic analysis module of computerized method 200 in FIGS. 2A-2B, may look for large “white gaps” between consecutive words in the same text-line, exceeding the average character width in the relevant line. Such gaps may imply a division of the line into separate columns, although no vertical same-color, e.g., black-line, exists. Yet, this probable division into columns should be confirmed by finding similar “white gaps”, in consecutive lines, at the same horizontal coordinates, whose width also exceed the average character width in the relevant line.

According to some embodiments of the present disclosure, the termination of a tabular structure may be determined by the first text-line that does not have the same columnar structure as the former lines. After detecting the boundaries of each column, as described above, the module, such as textographic analysis module of computerized method 200 in FIGS. 2A-2B may still distinguish between each column-header, if exists, and the rest of the cells belonging to that column. Column-headers describe the type of data that is expected in the cells of the relevant column. So, the column-header text-lines may be typically distinguished by being printed in a different font type or a different font size and containing a much lower rate of numeric-characters than in rest of the cells of the tabular structure.

According to some embodiments of the present disclosure, when the above criterion does not confidently distinguish between column-header lines and the rest of data in the tabular structure, a horizontal same-color line, e.g., black-line, below the column-header lines may signify the end of the column headers. In case of a table with a single text-line, without any preceding column header lines—alternate supporting terms may be looked for, to confirm that the single text-line is actually part of a table structure. For example, a. A horizontal-line exists just above this single-text and another one just below it. If the length of both horizontal lines is less than the whole text-line length, it may indicate that the table width is shorter than a full text-line length. b. The vertical gaps between the relevant text-line and the preceding and succeeding text-lines, are larger than the average vertical gap in its surrounding text-lines. c. Former documents from the same author and of the same document type, included tables with the same column structure and, with gaps between words at about the same horizontal coordinates.

According to some embodiments of the present disclosure, the module, such as textographic analysis module of computerized method 200 in FIGS. 2A-2B may find if the data in the specific column consists of an alpha-numeric string, for example, 02.10.2019, Tokyo, IGKS7930743. Then, it may determine if the majority of the data elements in the specific column seem to follow a logical or graphical pattern. (E.g.: all the elements include a single word of the format ASD-dddddd-2019 or DD.MM.YYYY or HH:MM:SS). Accordingly, an alternate OCR process may be applied on the exceptions, to impose a proper correction, which matches the expected pattern.

According to some embodiments of the present disclosure, related keywords in the column header may imply the data type of the elements in the specific column. For example, “Country”, “File number”, “Currency”, “date” or similar keywords in non-English languages. The automatic validation of the relevant data fields may be significantly enhanced if a file including possible values is available for the specific column. For example, a list of countries and cities in the world, to validate “city” or “country” columns, or a list including the relevant currency in each country, to validate a “currency” column. In such cases, recognition errors can be corrected whenever a unique fuzzy match occurs to a relevant possible value. E.g.: The misrecognized city “TOKVQ” will be corrected to “TOKYO”.

According to some embodiments of the present disclosure, numeric data fields, which include no alphabetic characters at all, may be separately validated and corrected. Yet, a numeric filed, e.g.: 127993, may not be necessarily an actual number that will be confirmed by arithmetic computations, but may as well be a file name or a document reference number or an item catalog number, etc. The actual field type may be commonly implied by the column header. For example, “Purchase order number” or “Catalog number” or similar keywords in the relevant language, may imply that the relevant number is not a numeric value to be validated by arithmetic computations. But, column headers which include words like “price”, “weight”, “distance” may imply a number. Also, a numeric field followed by a measurement unit such as, $, USD, kg., gr., km., pound, acre, KVA etc. may also imply a number which might be validated by arithmetic computations.

According to some embodiments of the present disclosure, a numeric data field may be validated by an arithmetic calculation of preceding numeric data fields in the same column.

According to some embodiments of the present disclosure, when more than a preconfigured percentage of the data fields in a specific column, e.g., 80% of the data fields in a specific column do not include any alphabetic character, it is assumed that the relevant column might probably include numeric data only. Any exception might be a misrecognized number, which should be rechecked and possibly corrected, using an alternate OCR process.

Furthermore, the validation process may assume that all the numbers in the column should probably have the same format and exactly the same font. So, any exception to the expected pattern may be treated as a possible misrecognition of the proper number. Hence, an alternate OCR process may be retried, to evaluate a possible correction, which matches the expected pattern. Examples to such corrections:
1) If all the numbers in the column consist of 10 digits. Yet, the leftmost digits in most of them are 8174, except one number, which starts with 3174. A possibility of improper recognition of the digit 8 by the digit 3 may be examined and if a re-OCR of the relevant image confirms it, an automatic correction to 8174 may be made.
2) If most of the numbers include a decimal point, followed by exactly 3 digits, then any exception to the pattern in the relevant column, like 1.3:50,0, may be considered as a possible misrecognized 13.500, caused by some noise in the relevant page. So, an alternate OCR process may be activated, aiming to correct it.

According to some embodiments of the present disclosure, numeric values in the first column of a table, may sometimes be just a counter of the relevant item within the table. In such cases, any exception to the ascending order of the relevant counters—might be suspected as a misrecognition and a correction may be operated.

According to some embodiments of the present disclosure, the numeric values in a column may frequently be a price or an amount, followed by a measurement unit e.g., Km., $, yard. Alternately, the measurement unit might be implied by the column header, rather than appear adjacent to the number, e.g., “Price in USD”, “Weight in Kg.” “Width in cm.”, or similar keywords in non-English languages.

According to some embodiments of the present disclosure, the validation process of numeric fields within a column, may be also confirmed by relevant arithmetic computations, which may validate or correct the number, according to the pattern within the specific column.

According to some embodiments of the present disclosure, the specific computations, which confirm the numbers in the column may vary according to the document type. For example, multiplying the number in the column headed “Unit Price” by the number in the column headed “Item Quantity” minus the number in the column headed by “Discount”, equals the number in the column headed by “Total Item Price”. If the expected equality is not achieved, then it may be assumed that one or more digits were misrecognized for example, the digit 8, whose left side wasn't properly printed, was misrecognized as 3. So, alternate recognitions may be retried, till an equation is reached.

According to some embodiments of the present disclosure, an arithmetic computation for confirming a column of numbers, might be by detecting a grand total, which equals the summation of those numbers. A column with numeric values, may also include subtotals, that are written in the same column. Such subtotals may be detected and handled in a different manner than all other numbers in the relevant column.

According to some embodiments of the present disclosure, to confirm a data field of subtotal—several terms may be searched which may distinguish the subtotal from other numbers in the same column. For example,
1) It is equal to the summation of one or more numbers, preceding it in the same column.
2) It is printed in a bolder or larger font.
3) The vertical gap between the suspected subtotal and the preceding number, in the same column, significantly exceed the average vertical gap between the rest of the preceding numbers.
4) The total number of words in the relevant line, having the same vertical coordinates, is significantly lower than the minimal number of words in the former lines. That is because a line which includes a subtotal is expected to include no further data in the same line, except for the word meaning “subtotal” or “total”, while other numbers in the same column—will usually include several other data fields in the same line, relating to the relevant number, detailing, for instance, that the relevant number is the price of 200 grams of coffee.
5) A horizontal black line exists between the suspected subtotal and the preceding number in the same column. If the former numbers, in the same column, are also preceded by a black line, then the black line preceding the suspected subtotal should be clearly different in length or width.

According to some embodiments of the present disclosure, when a column of numbers, that are expected to sum up to a grand total, still do not sum up, even after excluding subtotals that existed in the same column, the following options may be checked:
1) Either, an existing number in the column was misrecognized and a correction should be retried, by implementing an alternate OCR process, with the knowledge of the specific font.
2) Or, a number is missing in the relevant column, as it was probably erroneously considered as a picture by the OCR process. In this case, the expected location of the missing number in the column—will be determined by detecting a large vertical gap between the preceding and succeeding number, which significantly exceeds the average vertical distance between data elements within the relevant column. Hence, an alternate OCR process will be activated on the image in the expected location, trying to match it to the relevant numeric pattern, with the same font as all the other numbers in the column.

According to some embodiments of the present disclosure—the textographic analysis enables detection of numeric columns within table structures in any document, regardless of its language, and every numeric cell may be validated by arithmetic computations. For example, example 500 in FIG. 5 includes an invoice in Hebrew with two tabular structures. In each table—the leftmost column includes items prices, which are summed up into subtotals (16,483.40 and 4,425.30), appearing in the same column as all the other item prices. Yet, each subtotal may be distinguished from the item prices by the following criterions: (i) it equals the summation of the numbers, preceding it in the same column. (ii) a horizontal black line exists between the subtotal and the preceding number in the same column, as opposed to the former numbers, in the same column, which are not preceded by a black line. (iii) the row which includes the relevant subtotals include no further words at all, while the rows with the item prices include many words, detailing the relevant item. In this example, all relevant item prices are triple validated by arithmetic computations only: (i) the summation of all item prices, after subtracting relevant discount and adding V.A.T., detailed in the invoice, equals the total sum of the invoice. (ii) each item price equals the multiplication of two numbers (item unit price and item quantity, found in the same row). (iii) each subgroup of item prices sums up to a subtotal.

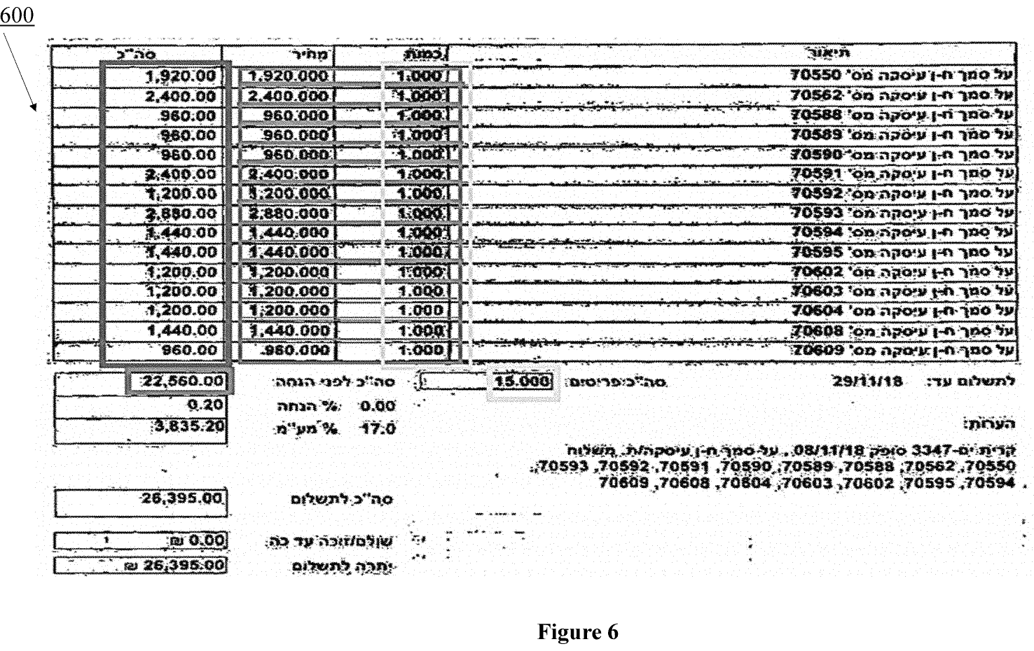

According to some embodiments of the present disclosure, in another example of a scanned paper-document e.g., of an invoice shown in example 600 in FIG. 6, having low quality image and noise within it, the OCR software did not recognize some of the item prices. The error-correction model may identify a uniform format of the item prices and of unit prices: two digits right to the digital point. Accordingly, erroneous prices, such as ‘2;4.0000’ are amended to ‘2,440.00’. Another numeric column, in the above example—the item quantities, are amended to another uniform format, including a number with exactly three figures right to the decimal point. Hence, managing to correct OCR errors like “,,1,000.” to “1.000”. By assuming a uniform format to all numbers in a numeric column and assuming same font for all numbers in the relevant column—100% of the OCR errors are corrected and validated by relevant arithmetic computation.

According to some embodiments of the present disclosure, a validation of several words, phrases or a sentence, within a column of a tabular structure, may be based on a fuzzy match to previously trained lists of items descriptions or a pre-prepared vocabulary of the words and phrases, appearing at least three times in the same document e.g., repetitive pattern, or in the aggregated data from previous documents of the same type i.e., category, and from the same author and the same addressee, i.e. recipient.

For example, if the phrase “Total price for items shipped in document number” appeared at least three times, it may be automatically added to the relevant vocabulary, to validate and correct any errors such as OCR errors in similar sentences, like: “Iotai price for ifems snipped in document humber”.

According to some embodiments of the present disclosure, item prices might be important key data to be extracted from commercial documents like invoices, purchase orders, etc. The item prices may be detected in a numeric column within a tabular structure, whose header matches a predefined list of keywords, like “Total Price” or “Amount” or “Extended Price”, implying item total price (typical in document types “Purchase Order”, “Invoice” and alike). If no such column header exists, then every numeric column is examined as the item prices column, which should sum up to a grand total.

According to some embodiments of the present disclosure, in cases that the item prices are in a different currency than the total price in the relevant document, the detected item prices may be first multiplied by the relevant currency conversion ratio. Commonly, words such as “ratio” or “rate”, or relevant other words, in the relevant predefined list, implying currency conversion ratio, may not be detected near the relevant number. A currency conversion ratio may be distinguished from other numbers within the document, as it is commonly a number with four to five digits right to the digital point, while prices commonly include up to three digits right to the decimal point.

According to some embodiments of the present disclosure, for example, a currency in documents such as an invoice may be implied in a vendor's address, as shown in element 415 in example 400A in FIG. 4A, the vendor's address is: ‘Haifa 4225740 IL’, which is an address in Israel, so it may imply ILS, However, when a string such as “$” or “USD” may be detected in the analyzed document, it may confirm that for a calculation of a total of the item prices may be converted from USD to ILS, as shown in element 440 in example 400D in FIG. 4D. The summation of the item prices—$1,935, is confirmed by: 1935*3.5900=6,946.65, and by: $645*3=$1,935. The total price of $1,935 may be converted to a total of ‘6,946.65, ’ which is the amount converted to ILS.

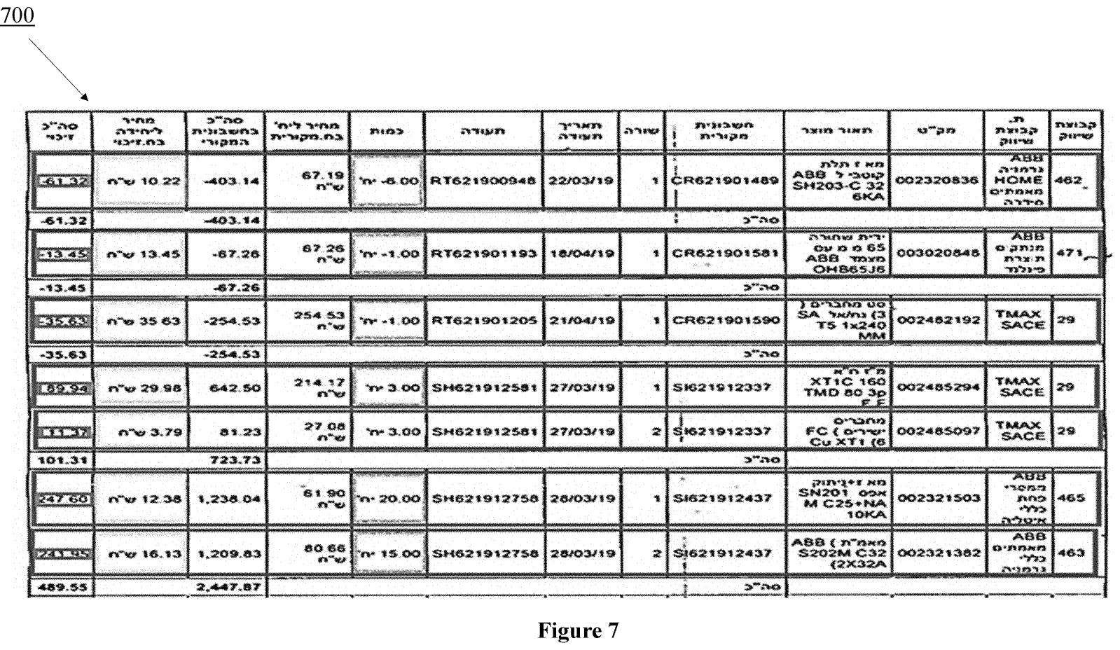

According to some embodiments of the present disclosure, for detecting the “horizontal boundaries” between relevant items within a tabular structure, which include, for example, details of ordered items, it is assumed that the locations of all the item prices, were already detected and validated in former analysis, by detecting two numbers which their multiplication equals the item price. All the rows within the tabular structure, which relate to a specific item are expected in the vicinity of the relevant item prices. If the group of lines, which relate to a specific item, consists of more than one line, than the relevant “border line” between two adjacent groups of lines, which relate to two different items may be determined by the maximal vertical gap between the relevant lines. If the vertical gaps between the relevant lines are equal, then, other criterions to detect the horizontal “border line” may be applied, such as a unique black horizontal line, which appears between the relevant item prices, which is the criterion for determining the “border line” between different items in the example in FIG. 7. The location of the “border line” between different items within a table may be determined according to the visual structure and layout of the table, regardless of the document language.

According to some embodiments of the present disclosure, some data fields are known to be alpha-numeric fields. For example, in invoices: item catalog number, or several alternate catalog numbers, item description, or reference to a document with the description, unique identification details, serial number, license number etc., and reference to further documents.

According to some embodiments of the present disclosure, a list of items, with repetitive patterns, may appear in a non-tabular structure. In such cases, a sequence of text lines, including similar patterns may be searched. For example, item: 500 gr. Butter. Shipment No. 177923, dated 18 Feb. 2015, item: 1000 cc. skim milk. Shipment No. 178257, dated 21 Feb. 2015, item: 2.5 kg. Oranges. Shipment No. 178861, dated 25 Feb. 2015. In this example of a non-tabular list, three data fields in each line, may be found, preceded by similar keywords (“Item:”, “Shipment No.”, “dated”, accordingly), printed in the same font and some of these keywords are even located in the same distance from the relevant key data. If the same pattern may be found in at least three lines of the same document, or, else, in other documents of the same type and from the same author and the same addressee, it may be considered a typical pattern, which should be saved to the relevant knowledge base. Hence, if a fuzzy match to such a pattern may be detected in further lines, it might be validated or corrected accordingly:
a. Misrecognition of the keyword such as, “item:” (like: “Iten;”), may be corrected, as well as any misrecognition of “Shipment No.” or “dated”, by assuming similar wording, fonts and relative horizontal distances.
b. Item description data field might be properly validated or corrected if the proper description already appeared several times before in the analyzed document and was saved to a data storage, such as data storage 150 in FIG. 1.
c. Shipment number may be detected to be a six-digit counter. An average daily increment and the standard deviation may be calculated, according to the correlating shipment dates. Any deviation, which may be more than a preconfigured number of times, e.g., five times, the computed standard deviation, may be considered a possible error. So, an alternate OCR software may be operated, to match the expected pattern that is stored in the data storage, such as data storage 150, in FIG. 1.

According to some embodiments of the present disclosure, in another example of non-tabular structure having multiple descriptions per item such as, ‘in shipment document number’, a four-digit shipment number, ‘dated’, supply date in DD/MM/YY format. The ‘in shipment document number’ and the supply date may be determined to be separated from an item description. An error-correction model may be activated if the daily increment of the shipment number exceeds five times a computed standard deviation. The item description and a relevant catalog number may be validated or corrected only if they appear more than once e.g., in the same document or in former look-alike documents, or if they already appear in a relevant supplier item list, or in the data storage, such as data storage 150 in FIG. 1, of previously supplied items.

According to some embodiments of the present disclosure, specific document types may include further key data fields to be detected, which are typical to those specific document types. E.g.: lawsuit number, insurance policy validity period, driving license expiration date, etc. The relevant data fields may be commonly detected by being preceded by specific keywords or being found in a column headed by such keywords. A list of keywords which may be related to each specific document type, may be provided as an input and may be stored in the data storage, such as data storage 150 in FIG. 1. Alternately, it may be detected by its unique format, e.g., number of characters; possible combinations of digits, capital letters or other character types; special font type and by the expected location within the document.

According to some embodiments of the present disclosure, if the same pattern appears at least a preconfigured number of times, e.g., three times in the same document or in several other documents which are of the same type and from the same author and the same addressee, for example, shipment numbers referenced in an invoice, which are: SH379915-2020, SH380190-2020, SH380785-2020, a textographic-learning module, such as textographic-learning module 120, in FIG. 1, may induce the format of related data fields, related font and relative location within the document or within a specific line. Accordingly, such data fields may be detected, validated or corrected, by a module such as textographic analysis module 140 in FIG. 1, in view of a concluded pattern of these specific data fields, which may be stored in the data storage, such as data storage 150 in FIG. 1.

According to some embodiments of the present disclosure, data fields which may not be computationally verified, as detailed above, for example, alpha-numeric fields in invoices such as:
a. item catalog number, or several alternate catalog numbers.
b. item description, or reference to a document with the description.
c. unique identification details—serial number, license number etc.
d. reference to further documents, detailing orders and supplies:

1) vendor price quotations, which preceded the tax invoice.

2) vendor documents, detailing invested time and materials.

3) vendor shipment certificates, with relevant supply dates.

4) vendor pro-forma invoice, which preceded the tax invoice.

5) customer purchase orders—reference numbers and dates.

6) customer certificate numbers, confirming the relevant supply.

7) other documents, referenced by the invoice or attached to it.

According to some embodiments of the present disclosure, a document may include references to other related documents. Such references may appear anywhere within the document and even as part of a descriptive field within a column in a table. Yet, such references to other document may usually include the relevant document reference number and a few words in its vicinity or in the relevant column header, describing the relevant document type, e.g. “items shipped in waybill number”. Such a phrase might appear in other look-alike documents, and will be learned by the textographic learning process, to indicate that the string following it is a waybill number. The relevant waybill may be also validated, by assuming that it should be at the same numeric range as in former relevant look-alike document. For example, the waybill reference number may exceed a former waybill reference number from the same supplier by at most 5%.

According to some embodiments of the present disclosure, operation 380 may comprise detecting one or more strings which imply chapters and paragraphs.

According to some embodiments of the present disclosure, to automatically understand the logical structure of any document, the module, such as textographic analysis module of computerized method 200 in FIGS. 2A-2B may look for relevant strings, out of the tabular structures, implying headers or numbers of chapters and paragraphs. Headers might be characterized by larger or bold fonts, capital letters, larger vertical gaps between the header and the preceding and following text line, etc. Also, chapters and paragraphs might be numbered with specific numbering structures, usually expected at the same horizontal coordinates (yet, in different vertical locations). For example, I. II. III. IV. or: 1.a. 1.b. 1.c. or: 1) 2) 3) or: 1.1 1.2 1.3 etc.

According to some embodiments of the present disclosure, assuming that the paragraph and chapter numbering should follow a logical sequence, misrecognitions might be easily detected and corrected, accordingly. For example, if paragraph number 1.2.7 was followed by 1.2.9, it may be assumed that 1.2.8 was improperly recognized. So, an alternate OCR process is applied to all the words that appear between the recognized 1.2.7 and 1.2.9, assuming that they are located at the same horizontal coordinates and probably printed in the same font type, to determine which word was actually an improper recognition of 1.2.8. For example, it was erroneously recognized as I.Z.B.

According to some embodiments of the present disclosure, when a paragraph or subparagraph are not numbered, but they are usually preceded and succeeded by vertical gaps, which are larger than the gap between other lines within the paragraph. The end-line may be expected to be terminated by a period, followed by spaces. After “understanding” the proper structure of chapters and paragraphs, using the formerly detected chapter and paragraph numbering, chapter and paragraph headers and the expected font type and common words and phrases within each paragraph, according to the vocabulary in the relevant data storage, which fits the specific document author and the specific document type—relevant text validation and correction may be implemented.

According to some embodiments of the present disclosure, the chapter and paragraph headers commonly include important keywords for automatic document tagging and are expected to appear in the first text-line of each chapter/paragraph or in a separate preceding text-line. It may be visually distinguished from the following text lines, by being printed in a different font type e.g., bolder, larger, underlined or italics.

According to some embodiments of the present disclosure, the text within each paragraph headers and also the text within the following lines, may be validated and corrected, not only by standard checking in relevant language dictionaries, but mainly by a fuzzy match to specific vocabularies of words and phrases, which appeared in former documents of the same type and from the same author and the same addressee, i.e., recipient. The process, which prepares these vocabularies, saves each word, appearing in the former documents, including the specific font in which it was printed, assuming that future documents will probably have similar graphical structure and will be styled using the same fonts.

According to some embodiments of the present disclosure, the extracting features of the document and of each data field within the document may comprise detecting one or more strings which imply chapters and paragraphs. For example, if the textographic analysis will be applied to the current document—it may characterize the chapter headers in the current document as follows: 1) Text justification within line: CENTERED. 2) Data filed type: ENGLISH_CAPITAL_LETTERS. 3) Distance from the left edge of the page to the left edge of the header: VARIABLE. 4) Width of the “virtual rectangle” which bounds the header: VARIABLE. 5) Height of the “virtual rectangle” which bounds the header: 3.5 mm. 6) Header numbering: NO. 7) Header font type: Times New Roman. 8) Header font size: 14. 9) Average character width in the header: 2.9 mm. 10) Average space between words in the header: 1.5 mm. 11) Minimal gap between the header line and the text line which precedes it: 8 mm. 12) Minimal gap between the header line and the text line which follows it: 8 mm. 13) Underline beneath the header: NO.

According to some embodiments of the present disclosure, the extracting features of the document and of each data field within the document may further comprise detecting chapters paragraphs structure within each chapter. For example, if the textographic analysis will be applied to the current document—it may characterize the paragraphs within each chapter as follows: Paragraph header: NO. Text lines within a paragraph: 1) Text justification within line: LEFT. 2) Paragraph numbering: [0001]-[0099] [00100]-[00999]. 3) Paragraph numbering font type: Times New Roman bold. 4) Paragraph numbering font size: 12. 5) Distance from the left edge of the page to the leftmost edge of paragraph numbering: 17 mm. 6) Width of the “virtual rectangle” which bounds the paragraph numbering: 12 mm. 7) Distance from the left edge of the page to the leftmost edge of paragraph text lines: 17 mm. 8) Width of the “virtual rectangle” which bounds the longest text line: 170 mm. 9) Height of the “virtual rectangle” which bounds the highest text line: 3 mm. 10) Average gap between two consecutive lines within the paragraph: 4 mm. 11) Dominant font type in the paragraph: Times New Roman. 12) Dominant font size in the paragraph: 12. 13) Average character width in the paragraph: 1.6 mm. 14) Average space between words within the paragraph: 3 mm.

According to some embodiments of the present disclosure, there may be several basic key data fields, which are common to most types of documents, and are automatically extracted from any document, as already detailed in former paragraphs such as document type, document author, document addressee, document subject, document reference number and document date. Further data fields are also detected and validated in every document, after analyzing the document structure and the format of the text within it, as detailed in the following paragraphs. Yet, for specific types of documents, it might be necessary to identify special types of data fields as key data to be extracted from the relevant type of document.

According to some embodiments of the present disclosure, assuming that a list of key data fields to be extracted from specific document types, was already predefined and stored in a data storage, such as data storage 150 in FIG. 1. For each key data, the following information may be predefined, to enable matching of a relevant data field with the appropriate key data:
a. A list of keywords, which may appear near the relevant key data field, or in the header of the relevant column, and will imply the appropriate key data type, matching a relevant detected data field.
b. Special format of the relevant key data, that may assist distinguishing it from other data found in the document. For example, a lawsuit number or a project number, with special format such as ZLS-70152/2020.
   For example, key data fields that may be extracted from tax invoices:
a. Total charged sums in the invoice:

1) Global-Discount.

2) Global-shipment-fees.

3) Total-Sum-Including-VAT.

4) Total-VAT-Exempt-Sum.

5) Total-VAT-Chargeable-Sum.

6) Total-VAT-Sum.

7) Total-Prices-Currency.

8) Currency-Conversion-Ratio-from-Item-Prices-to-Total-Prices.
b. Relevant information about each item, detailed in the invoice:

9) Item-Catalog-Number (possible several alternate values).

10) Item-Description (possible several alternate descriptions).

11) Item-Unit-Price-Excluding-VAT.

12) Item-Unit-Price-Currency.

13) Item-Quantity.

14) Item-Agreed-Discount.

15) Item-Total-Price-Excluding-VAT.

16) Item-Total-Price-Including-VAT.
c. Reference to relevant documents preceding the current invoice, from the same author (who is the vendor in the relevant invoice):

17) Relevant-Price-List-or-Price-Quotation-Number.

18) Date-of-the-Relevant-Price-List-or-Price-Quotation.

19) Invested-Time-and-Materials-Document-Number.

20) Date-of-the-Document-Detailing-Invested-Time-and-Materials.

21) Reference-Number-of-a-Document-Detailing-Shipped-Items.

22) Date-of-the-Document-Detailing-Shipped-Items.

23) Number-of-a-previous-Invoice-Updated-by-the-Current-Invoice.

24) Date-of-the-Previous-Invoice-Updated-by-the-Current-Invoice.
d. Reference to former relevant documents prepared by the same addressee (who is actually the customer in the relevant tax invoice):

25) Relevant-Customer-Purchase-Order-Number.

26) Date-of-the-Relevant-Customer-Purchase-Order-Number.

27) Confirmation-Number-for-Receiving-the-Relevant-Items.

28) Date-of-Receiving-the-Relevant-Items.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for classifying a document and detecting and validating key data within the document, the computerized-method comprising:
(i) receiving a stream of uniform format documents, for each document in the stream of uniform format documents, operating a textographic analysis module to: (a) determine a category, an author and recipient of each document by: (i) extracting features of the document and features of one or more data fields within it; and (ii) comparing the extracted features to prestored characteristics of one or more categories of documents in the data storage; (b) detect one or more key data, based on the determined category to ascribe each detected key data to corresponding one or more data fields within the document;
(ii) operating a textographic-learning module on the received stream of uniform format documents to: (a) sort documents in the stream of uniform format documents into groups of look-alike documents (b) store in a data storage the extracted features of the one or more data fields for the ascribed key data, for each group of look-alike documents; and (c) assign each document in the stream of uniform format documents to a group of look-alike documents and store the assignment of each document in the data storage;
(iii) validating each determined key data in each document, in the stream of uniform format documents, by matching features of each data field ascribed to the one or more key data to corresponding recognized features of one or more data fields which are ascribed to same key data in the assigned group of look-alike documents; and
(iv) displaying via a display unit, the category, author, recipient and the validated key data of each document in the stream of uniform format documents,
wherein extracting features of the document and of each data field within the document comprises:
(a) determining a graphical structure;
(b) detecting a page header and footer to validate an author;
(c) detecting and validating a recipient;
(d) detecting one or more strings to derive a category of document;
(e) detecting (i) a subject of the document; (ii) a reference number; (iii) dates; (iv) creation date and time; and (v) key data;
(f) converting numeric data to a predetermined format;
(g) detecting one or more tabular structures to validate data within each column in the detected one or more tabular structures; and
(h) detecting one or more strings which imply chapters and paragraphs.

2. The computerized-method of claim 1, wherein the sort documents in the stream of uniform format documents into groups of look-alike documents comprises: detecting common features of documents having the same category, author and recipient.

3. The computerized-method of claim 1, wherein each document in the received stream of uniform format documents is in any language and wherein each document has been received in a digital uniform format or has been converted to a digital file by operating a scanning software on a paper-document.

4. The computerized-method of claim 3, wherein a document in the received stream of uniform format documents is a paper-document that has been converted to a digital file, the computerized-method is further comprising: applying an image enhancement operation to yield an enhanced image by eliminating noise and other distortions, and then resizing an enhanced image of each page of the received document into a preconfigured size with uniform margins.

5. The computerized-method of claim 4, wherein the computerized-method is further comprising applying an Optical Character Recognition (OCR) process to the enhanced image to detect text within the image and to yield a uniform format document.

6. The computerized-method of claim 5, wherein the detected text within the image includes one or more OCR errors which are erroneous recognition of the text within the image and wherein the detecting and validating key data in the document is further operating an OCR-error correction model according to the validation of key data.

7. The computerized-method of claim 1, wherein the predetermined format is a standard format that is used in the United States of America.

8. The computerized-method of claim 1, wherein the validating data within each column in the detected one or more tabular structures further comprising determining a pattern of the data.

9. The computerized-method of claim 8, wherein the pattern of the data is selected from at least one of: (i) an alphanumeric string; (ii) a numeric string;

10. The computerized-method of claim 9, wherein the numeric string is followed by a measurement unit or the measurement unit is specified within a header of the column in which the numeric string is located.

11. The computerized-method of claim 1, wherein the validating data within each column in the detected one or more tabular structures further comprising verifying that each numeric data field in a column has the same format and the same font.

12. The computerized-method of claim 1, wherein a validating data of each numeric data field within each column in the detected one or more tabular structures comprising identifying a subtotal in a column of numeric data fields.

13. The computerized-method of claim 12, wherein the identifying of subtotal further comprising checking: (i) a subtotal equals a summation of one or more preceding numeric data in same column; (ii) a print of the numeric data field as bolder or larger font than the other numeric data fields in the same column (iii) a vertical gap between the identified subtotal and a preceding numeric data field in the same column exceeds the average vertical gap between the rest of the preceding numeric data fields in the same column; (iv) a horizontal line exists between the identified subtotal and a preceding number in the same column; (v) a horizontal line between other preceding numeric fields which is in a different length; and
(vi) a total number of words in a line is lower than a total number of words in former lines.

14. The computerized-method of claim 1, wherein the stream of uniform format documents includes documents in Portable Document Format (PDF).

15. The computerized-method of claim 1, the graphical structure is determined based on: (i) a location and length of each vertical line in every page of the document; (ii) a location and length of each horizontal line in every page of the document; (iii) coordinates of left edge and right edge of a printed area in the document, text-line height, vertical gap between top of the text-line and bottom of the preceding text-line; (iv) detection of column structures, separated by vertical lines or by “white vertical gaps”; (v) coordinates of left edge and right edge of each string within the document, string height, font size, font type, bold or italic features of each string, proportional or monospaced font, combination type of characters of each string.

16. The computerized-method of claim 15, wherein a vertical line is a sequence of pixels, which are positioned in a horizontal coordinate, that at least a preconfigured percentage of them are of same color, and a total sequence height that exceeds twice the maximal character height within a page in the document.

17. The computerized-method of claim 15, wherein a horizontal line is a sequence of pixels, which are positioned in a vertical coordinate, that at least a preconfigured percentage of them are of same color, and a total sequence width that exceeds twice the maximal character width within a page in the document.

18. The computerized-method of claim 1, wherein each category and author and recipient includes one or more groups of look-alike documents.

19. The computerized-method of claim 1, the computerized-method further comprising uploading each document to related one or more applications in a computerized system of an organization based on the determined category of each document.

20. A computerized-system for classifying a document, the computerized-system comprising:
a processor;
a data storage;
a memory to store the data storage; and
a display unit,
said processor is configured to:
(i) receive a stream of uniform format documents, for each document in the stream of uniform format documents, operating a textographic analysis module to: (a) determine a category, an author and recipient of each document by: (i) extracting features of the document and features of one or more data fields within it; and (ii) comparing the extracted features to prestored characteristics of one or more categories of documents in the data storage; (b) detect one or more key data, based on the determined category to ascribe each detected key data to corresponding one or more data fields within the document;
(ii) operate a textographic-learning module on the received stream of uniform format documents to: (a) sort documents in the stream of uniform format documents into groups of look-alike documents; (b) store in a data storage the extracted features of the one or more data fields for the ascribed key data, for each group of look-alike documents; and (c) assign each document in the stream of uniform format documents to a group of look-alike documents and store the assignment of each document in the data storage;
(iii) validate each determined key data in each document, in the stream of uniform format documents, by matching features of each data field ascribed to the one or more key data to corresponding recognized features of one or more data fields which are ascribed to same key data in the assigned group of look-alike documents; and
(iv) display via a display unit, the category, author, recipient and the validated key data of each document in the stream of uniform format documents,
wherein extracting features of the document and of each data field within the document comprises:
(a) determining a graphical structure;
(b) detecting a page header and footer to validate an author;
(c) detecting and validating a recipient;
(d) detecting one or more strings to derive a category of document;
(e) detecting (i) a subject of the document; (ii) a reference number; (iii) dates; (iv) creation date and time; and (v) key data;
(f) converting numeric data to a predetermined format;
(g) detecting one or more tabular structures to validate data within each column in the detected one or more tabular structures; and
(h) detecting one or more strings which imply chapters and paragraphs.
